(19) United States
(12) Patent Application Publication
(10) Pub. No.: US 2003/0221853 A1
(43) Pub. Date: Dec. 4, 2003

(54) Apparatus for manufacturing electronic device, method of manufacturing electronic device, and program for manufacturing electronic device

(76) Inventor: Masakuni Shiozawa, Chino-shi (JP)

Correspondence Address: HARNESS, DICKEY & PIERCE, P.L.C., P.O. BOX 828, BLOOMFIELD HILLS, MI, 48303, US

(21) Appl. No.: 10/394,476

(22) Filed: Mar. 21, 2003

(30) Foreign Application Priority Data
Mar. 22, 2002 (JP) 2002-081220
Mar. 22, 2002 (JP) 2002-081221
Mar. 22, 2002 (JP) 2002-081222
Mar. 25, 2002 (JP) 2002-084347
Jan. 31, 2003 (JP) 2003-024650

(51) Int. Cl. H02G 3/08; H01J 5/00

(52) U.S. Cl. 174/50; 174/52.1

(57) ABSTRACT

Quality control of product manufacturing is performed with a simple structure and, in addition, damage of a product when a production line is stopped is avoided. A preheating block approaches a circuit substrate having a predetermined length along a tape substrate from a predetermined position by gradual upward movements to carry out preheating and is then returned to the predetermined position, a main heating block arranged close to the preheating block is made to contact the circuit substrate on which the preheating has been carried out and which is transported in a predetermined tact to apply peak heating and is then restored to the predetermined position, and a cooling block accesses the circuit substrate to which the peak heating has been applied to cool the circuit substrate and is then returned to the predetermined position.

### BACKGROUND

1. Technical Field of the Invention

The present invention relates to an apparatus for manufacturing an electronic device, a method of manufacturing an electronic device, and a program for manufacturing an electronic device, and, more particularly, the present invention is applicable to a solder reflow process of a tape substrate on which electronic components are mounted.

2. Description of the Related Art

In manufacturing a semiconductor device, there is a process for mounting, for example, semiconductor chips on a circuit substrate of a COF (Chip On Film) module, a TAB (Tape Automated Bonding) module, and others, by a reflow method.

FIG. 17 is a view illustrating a conventional method of manufacturing an electronic device.

As shown in FIG. 17, during the reflow process, there are provided heater zones 811 to 813 and a cooling zone 814 along the transport direction of a tape substrate 801 indicated by the right-pointing arrow. In the reflow process, if peak heat is suddenly applied, reflow cracks may be generated in a bonding member such as an adhesive between the tape substrate 801 and in a semiconductor chip or the semiconductor chip itself, or solder bonding through solder paste may not be carried out well. For this reason, preheating is applied in the heater zones 811 and 812 and the peak heat is applied in the heater zone 813. The peak heat is indicated by a solder melting point +α. Furthermore, the reflow method in the reflow process can employ an air-heating method using the hot-air circulating method, a lamp heating method, a far infrared ray method and others.

When terminals of the semiconductor chip are bonded onto the wiring of the circuit substrate by melting the solder paste, the semiconductor chip is fixed on the circuit substrate by means of cooling in the cooling zone 814. In the cooling zone 814, a method of circulating low temperature air has been studied.

However, since the heat conductivity is not good in the air heating method using hot-air circulation, the heating time in the heater zones 811 to 813 is increased, thus hindering the improvement in productivity. Further, the method using hot-air circulation requires a large scale mechanism for circulating the hot air, which is an obstacle to miniaturizing the equipment.

Furthermore, since spot heating is performed in the lamp heating method or the far infrared ray method, a light-shielding structure is required between the heater zones 811 to 813 and as a result, the structure of the required equipment becomes large.

Furthermore, in such reflow methods, the heat dissipation property is great. Therefore, when the heating or the cooling is carried out on the tape substrate 801 in a predetermined block length unit, it is difficult to adjust the processing time corresponding to the block length. Furthermore, since heat is transferred between the heater zones 811 to 813, it is difficult to clearly maintain a boundary temperature between the heater zones 811 to 813.

Furthermore, in the aforementioned reflow method, when a production line is stopped for a given time for any reason, the heating is stopped by turning off a switch controlling a heat source. However, when a line is stopped for more than the given time, it is not possible to remove the products from the heating process, so it is difficult to avoid damage of product.

Additionally, since heat is transferred to the tape substrate 801 which is positioned short of the heater zone 811 and is to be heated next, it is difficult to perform quality control of the product.

Furthermore, when the stopped lined is restored, the preheating, the peak heating and the cooling are performed again, but since the switch of the heating source is required to be turned on after the damaged parts of the products are removed from reflow process area, the waiting time until normal operation for heating or cooling can be resumed is lengthened.

Moreover, since the cooling is carried out with low temperature air in the cooling zone 814 in the reflow process, the cooling time is lengthened and therefore it is difficult to prevent thermal oxidation and specifically when the solder paste is free of lead.

Therefore, an object of the present invention is to provide an apparatus for manufacturing an electronic device, a method of manufacturing an electronic device and a program for manufacturing an electronic device which make it possible to easily control the quality of the product produced with a simple structure and to avoid product damage when a production line is stopped.

### SUMMARY

In order to solve the aforementioned problems, an apparatus for manufacturing an electronic device according to an aspect of the present invention comprises heat generating means for raising the temperature of an area to be heated of a continuous body by controlling the distance between the heat generating means and the area of the continuous body to be heated. The continuous body includes a plurality of circuit blocks and an electronic component mounting area is provided on every circuit block.

By doing so, it is possible to easily control the heating condition of the area to be heated by controlling the distance between the area to be heated and the heat generating means, and even when the continuous body (and therefore the area to be heated) is stopped in the midcourse of transport down the production line, it is also possible to easily control the temperature of the area to be heated. For this reason, it is possible to suppress sudden variations in temperature in the reflow process and reduce thermal damage on the electronic components, the soldering materials, and elsewhere. In addition, when a line is stopped, it is possible to easily avoid the thermal damage on products, and it is also possible to easily control the quality in the reflow process while suppressing the enlargement of required equipment.

Further, in an apparatus for manufacturing an electronic device according to an aspect of the present invention, the heat generating means raises the temperature of the area to be heated by approaching or coming into contact with at least a part of the area to be heated of the continuous body.

By doing so, it is possible to control the heating condition of the area to be heated by using radiated heat or conductive heat, and it is also possible to suppress circumferential dissipation of the heat generated by the heat generating means. As a result, it is possible to accurately control the temperature profile in a circuit block unit being heated and to easily perform quality control. In addition, the shielding structure of the hot-air circulating method, and the light-shielding structure of the lamp heating method and the far infrared ray method are not required, and therefore it is possible to reduce the space used.

Furthermore, by contacting the heat generating means with the area to be heated of the continuous body, it is possible to rapidly raise the temperature of the circuit block (where the area to be heated is located) and shorten the tact time required for transport. For this reason, it is possible to match the transport tact in a solder applying process or a mounting process with the transport tact of the reflow process, and it is also possible to carry out the solder applying process, the mounting process and the reflow process simultaneously.

Furthermore, in an apparatus for manufacturing an electronic device according to an aspect of the present invention, the heat generating means contacts, from the back side or the surface side, the continuous body from either the front side or back side thereof.

Here, in a case that the heat generating means contacts the continuous body from the back side of the continuous body, even if electronic components having different heights are arranged on the continuous body, it is possible to efficiently transfer heat to the continuous body and thus to stably carry out the reflow process.

Furthermore, in a case that the heat generating means contacts the continuous body from the front side of the continuous body, it is possible to contact the heat generating means directly with any electronic components provided thereon. This prevents direct contact of the heat generating means with the continuous body. Therefore adhesion of the continuous body to the heat generating means is prevented.

Furthermore, in an apparatus for manufacturing an electronic device according to an aspect of the present invention, the heat generating means controls the temperature of the area to be heated step-by-step, by controlling of the speed or position of movement.

By doing so, it is possible to control the temperature of the area to be heated step-by-step, without using a plurality of heat generating means having different temperatures. For this reason, it is possible to prevent sudden variations in temperature in carrying out the reflow process, reduce the space used, and suppress the deterioration of the quality in the reflow process.

Furthermore, in an apparatus for manufacturing an electronic device according to an aspect of the present invention, the heat generating means moves vertically or horizontally.

Here, even when the area to be heated is broad, moving the heat generating means up and down, makes it possible to raise or lower the temperature of the area to be heated step-by-step while maintaining uniformity in the temperature distribution in the area to be heated. In addition, it is also possible to rapidly retract the heat generating means from the area to be heated while suppressing a temperature increase in the area of the reflow zone.

Accordingly, even when a transport system is stopped due to any trouble in the production line, it is possible to reduce the required space and to rapidly avoid thermal damage of the area to be heated, and it is possible to suppress the deterioration of the quality in the reflow process.

Furthermore, since the heat generating means moves horizontally, it is possible to match the transport speed of the continuous body to the moving speed of the heat generating means, reduce differences in the heating temperature by using the stopped position of the area to be heated and to maintain uniformity in heating time even when the product pitches are different from each other.

Furthermore, in an apparatus for manufacturing an electronic device according to an aspect of the present invention, the heat generating means contacts the same area to be heated a plurality of times.

By doing so, since thermal damage of the area to be heated is avoided, even when the heat generating means is retracted, it is possible to restore the area to be heated to the original temperature while preventing sudden variations in temperature and to suppress the deterioration of the quality in the reflow process while reducing the required space.

Furthermore, in an apparatus for manufacturing an electronic device according to an aspect of the present invention, the heat generating means has a contact area which is greater than a solder applying area applied to a circuit block, and the heat generating means raises the temperatures of a plurality of circuit blocks simultaneously.

By doing so, by contacting the area to be heated with the heat generating means, it is possible to carry out the reflow process on a plurality of circuit blocks simultaneously and to carry out the reflow process without replacing the heat generating means even when the product pitches along the continuous body are different from each other.

Furthermore, in an apparatus for manufacturing an electronic device according to an aspect of the present invention, the heat generating means has a plurality of contact areas having different predetermined temperatures, and, by sequentially contacting the contact areas with the area to be heated, the heat generating means raises the temperature of the area to be heated step-by-step.

By doing so, it is possible to control the heating condition of the area to be heated by using conductive heat and to raise the temperature of the area to be heated step-by-step while suppressing circumferential dissipation of the heat generated by the heat generating means. For this reason, even when the shielding structure of the hot-air circulating method or the light-shielding structure of: the lamp heating method or the far infrared ray method are not employed, it is possible to control the temperature profile step-by-step in a circuit block unit where the area to be heated is located and easily perform quality control while reducing the space used.

Furthermore, by making the heat generating means sequentially approach the area to be heated, it is possible to rapidly raise the temperature of the circuit block step-by-step rapidly and shorten the tact time in transport while preventing sudden variations in the temperature of the area to be heated. For this reason, it is possible to match the transport tact in the solder applying process or the mounting process with the transport tact in the reflow process while suppressing quality deterioration in the reflow process, and carry out the solder applying process, the mounting process and the reflow process simultaneously.

Furthermore, in an apparatus for manufacturing an electronic device according to an aspect of the present invention, the plurality of contact areas having different predetermined temperatures are sequentially arranged in parallel in a transport direction of the continuous body.

By doing so, while transporting the continuous body, it is possible to sequentially contact the area to be heated with a plurality of contact areas having different predetermined temperatures, to raise the temperature of the area to be heated step-by-step without movement of the heat generating means and to carry out the reflow process on the plurality of areas to be heated simultaneously.

For this reason, it is possible to shorten the tact time in the reflow process while preventing sudden variations in the temperature of the area to be heated, and to efficiently carry out the reflow process while maintaining product quality.

Furthermore, in an apparatus for manufacturing an electronic device according to an aspect of the present invention, a gap is provided between the contact areas having different predetermined temperatures.

By doing so, it is possible to definitely maintain a temperature difference at the boundary between the contact areas which are different in predetermined temperatures, to accurately control the temperature profile of each area to be heated, and to improve product quality in the reflow process.

Furthermore, in an apparatus for manufacturing an electronic device according to an aspect of the present invention, the plurality of contact areas having different predetermined temperatures can be moved individually.

Moreover, while continuing to preheat the specific circuit block, it is possible to stop the main heating of other blocks. For this reason, even when the main heating is stopped in the mid-course of the heating process, it is possible to prevent the preheating process from being stopped to thereby reduce product failures.

Furthermore, in an apparatus for manufacturing an electronic device according to an aspect of the present invention, a contact surface of the heat generating means which contacts the area to be heated is flat.

By doing so, it is possible to smoothly transport the continuous body while contacting the continuous body with the contact surface of the heat generating means. For this reason, when the heating is carried out by contacting the continuous body with the contact surface of the heat generating means, it is possible to reduce the movement of the heat generating means and to shorten the tact time in the reflow process.

Furthermore, in an apparatus for manufacturing an electronic device according to an aspect of the present invention, the contact surface of the heat generating means is provided with a concave portion corresponding to the position where a semiconductor chip is arranged in the area to be heated.

By doing so, it is possible to prevent the heat generating means from directly contacting the area on which a semiconductor chip is arranged. For this reason, even when the semiconductor chip, which is vulnerable to heat, is mounted on the continuous body, it is possible to suppress thermal damage to the semiconductor chip.

Furthermore, an apparatus for manufacturing an electronic device according to an aspect of the present invention further comprises shutter means removeably positionable between the area to be heated of the continuous body and the heat generating means.

By doing so, when the area to be heated is removed from the heat generating means, it is possible to suppress the continuous heating of the area to be heated from heat radiated from the heat generating means and, even when the time away from the heating means is prolonged, it is possible to suppress thermal damage on the area to be heated.

Furthermore, an apparatus for manufacturing an electronic device according to an aspect of the present invention further comprises: timer means for tracking the time of heating up the area to be heated by the heat generating means; and retracting means for retracting the heat generating means from the area to be heated when the heating time exceeds a predetermined time.

By doing so, even when a transport system is stopped due to any trouble in the production line during heating of the area to be heated or the like, it is possible to rapidly avoid thermal damage on the area to be heated and to suppress the deterioration of the quality in the reflow process.

Furthermore, an apparatus for manufacturing an electronic device according to an aspect of the present invention further comprises: a supporting stand for supporting the heat generating means; and slide means for sliding the supporting stand along the transport direction of the continuous body.

By doing so, it is possible to match the position of the heat generating means to the product pitches as confirmed by the naked eye and, even when the product pitches are different from each other, it is possible to maintain uniformity in heating time.

Furthermore, an apparatus for manufacturing an electronic device according to an aspect of the present invention further comprises auxiliary heating means for heating the area to be heated of the continuous body from a direction that is different from the direction of the heat generating means.

By doing so, even when the area to be heated is removed from the heat generating means, it is possible to maintain the temperature of the area to be heated at more than a predetermined temperature and to prevent product failures due to an excessive decrease in the temperature of the area to be heated.

Furthermore, an apparatus for manufacturing an electronic device according to an aspect of the present invention further comprises temperature lowering means for lowering the temperature of the area to be heated the temperature of which has been raised by the heat generating means.

By doing so, it is possible to rapidly lower the temperature of the area to be heated and improve the solder wettability, stabilize the bonding, and prevent thermal oxidation of the solder.

Furthermore, in an apparatus for manufacturing an electronic device according to an aspect of the present invention, the temperature lowering means includes a flat plate member having a plurality of coolant blowout holes along a surface facing the area to be heated.

By doing so, even when an electronic component is mounted on the area to be heated, it is possible to distribute the coolant uniformly in every corner of the area to be heated and efficiently lower the temperature of the area to be heated.

Furthermore, in an apparatus for manufacturing an electronic device according to an aspect of the present invention, the temperature lowering means includes a covering and sandwiching opening having a U-shaped cross-section for covering and sandwiching the top and bottom of the area to be heated from the vertical direction and a plurality of coolant blowout holes provided on the inner surface of the covering and sandwiching opening.

By doing so, it is possible to cool the area to be heated from the top and bottom of the area to be heated, and efficiently lower the temperature of the area to be heated.

Furthermore, in an apparatus for manufacturing an electronic device according to an aspect of the present invention, the temperature lowering means includes an area having a temperature that is lower than the temperature of the heat generating means, and, by contacting the lower temperature area with at least a part of the area to be heated of the continuous body, the temperature lowering means lowers the temperature of the area to be heated.

By doing so, it is possible to control the cooling condition of the area to be heated by using conductive heat, improve the cooling efficiency, and shorten the cooling time.

For this reason, it is possible to shorten the tact time in the cooling process, suppress thermal oxidation of the solder and the deterioration of product quality, and efficiently carry out the reflow process.

Furthermore, in an apparatus for manufacturing an electronic device according to an aspect of the present invention, the lower temperature area has a contact area that is larger than an area to which solder. is applied, and the temperature lowering means lowers the temperatures of a plurality of circuit blocks simultaneously.

Accordingly, by contacting the area to be heated with the lower temperature area, it is possible to cool the plurality of circuit blocks simultaneously, and, even when the product pitches are different from each other, it is possible to perform cooling without exchanging the temperature lowering means and to improve production efficiency.

Furthermore, in an apparatus for manufacturing an electronic device according to an aspect of the present invention, the lower temperature area is located at a previous or subsequent stage of the heat generating means or between heat generating means that are in parallel.

By doing so, during transportation of the continuous body, it is possible to contact the area to be heated with the lower temperature area then the heat generating means, lower the temperature of the area to be heated while fixing the lower temperature area than the heat generating means, and carry out the cooling on a plurality of areas to be heated simultaneously.

Accordingly, it is possible to shorten the tact time in cooling, suppress thermal oxidation of the solder and the deterioration of product quality, and efficiently carry out the reflow process.

Furthermore, by arranging the lower temperature area which has lower temperature than the heat generating means at a previous or subsequent stage of the heat generating means or between heat generating means that are in parallel, it is possible to prevent the heat generated by the heat generating means from being transferred to an area which does not contact the heat generating means, accurately maintain the temperature profile of the area to be heated and improve the product quality in the reflow process.

Furthermore, in a method for manufacturing an electronic device according to an aspect of the present invention, by controlling the distance between the heat generating means and the area to be heated of the continuous body in which an electronic component mounting area is provided on every circuit block, the temperature of the area to be heated is raised.

By controlling the distance between the area to be heated and the heat generating means, it is possible to easily control the heating condition of the area to be heated, and even when the area to be heated is stopped during transport, it is possible to easily control the temperature of the area to be heated. For this reason, it is possible to shorten the tact time in the reflow process, suppress sudden variations in the temperature of the reflow process thereby reducing damage on the electronic components or the soldering materials and efficiently carry out the reflow process while suppressing the quality deterioration in the reflow process.

Furthermore, in a method of manufacturing an electronic device according to an aspect of the present invention, by making the heat generating means approach or contact at least a part of the area to be heated of the continuous body, the temperature of the area to be heated can be raised.

By doing so, it is possible to control the heating condition of the area to be heated by using radiated heat and conductive heat and suppress the circumferential dissipation of heat generated by the heat generating means. For this reason, it is possible to accurately control the temperature profile of a circuit block unit and to easily control the quality. In addition, the shielding structure of the hot-air circulating method and the light-shielding structure of the lamp heating method or the far-infrared ray method are not required and it is possible to reduce the space used.

Furthermore, by contacting the heat generating means with the area to be heated of the continuous body, it is possible to rapidly raise the temperature of the circuit block located there and shorten the tact time during transport. For this reason, it is possible to match the transport tact in the solder applying process or the mounting process and the transport tact in the reflow process, and carry out the solder applying process, the mounting process and the reflow process simultaneously.

Furthermore, in a method of manufacturing an electronic device according to an aspect of the present invention, a plurality of circuit blocks are contacted with the heat generating means simultaneously.

accordingly, by contacting the area to be heated with the heat generating means, it is possible to carry out the reflow process on a plurality of circuit blocks simultaneously and improve production efficiency.

Furthermore, in a method of manufacturing an electronic device according to an aspect of the present invention, the same circuit block is contacted with the heat generating means a plurality of times.

By doing so, even when the heat generating means is separated from the area to be heated in order to avoid thermal damage on the area to be heated, it is possible to restore the original temperature to the area to be heated while preventing sudden variations in temperature of the area to be heated, and suppress the deterioration of quality in the reflow process while saving space.

Furthermore, a method of manufacturing an electronic device according to an aspect of the present invention comprises steps of: transporting a first area to be heated of a continuous body onto a heat generating means; raising the temperature of the first area to be heated by contacting the first area to be heated, which has been transported onto the heat generating means, with the heat generating means; transporting a second area to be heated of the continuous body onto the heat generating means; and raising the temperature of the second area to be heated by contacting the second area to be heated, which has been transported onto the heat generating means, with the heat generating means.

Accordingly, by transporting the continuous body onto the heat generating means, it is possible to contact the area to be heated with the heat generating means, and shorten the tact time in the reflow process and to improve production efficiency.

Furthermore, a method of manufacturing an electronic device according to an aspect of the present invention comprises steps of: transporting an area to be heated of a continuous body onto a heat generating means; and raising the temperature of the area to be heated step-by-step, by making the heat generating means approach the area to be heated step-by-step.

Accordingly, it is possible to raise the temperature of the area to be heated step-by-step by using the heat generating means which has a constant. temperature and suppress thermal damage in the reflow process while reducing the space used.

Furthermore, a method of manufacturing an electronic device according to an aspect of the present invention comprises a step of retracting the heat generating means from the area to be heated, during or after the heating of the area to be heated by the heat generating means.

Accordingly, even when a transport system is stopped during the heating of the area to be heated or the like, it is possible to rapidly avoid thermal damage on the area to be heated and to suppress the deterioration of quality in the reflow process.

Furthermore, a method of manufacturing an electronic device according to an aspect of the present invention comprises a step of inserting a heat-shielding plate between the retracted heat generating means and the area to be heated.

Accordingly, when the heat generating means is retracted from the area to be heated by a distance through which the heat-shielding plate can be inserted between the heat generating means and the area to be heated, it is possible to suppress thermal damage on the area to be heated and the deterioration of quality in the reflow process while saving space.

Furthermore, a method of manufacturing an electronic device according to an aspect of the present invention comprises a step of again contacting the heat generating means which has been separated from the area to be heated, with the area to be heated.

By doing so, even when the heat generating means is separated from the area to be heated in order to avoid thermal damage on the area to be heated, it is possible to easily restore the area to be heated to the original temperature while preventing sudden variations in the temperature of the area to be heated.

Furthermore, a method of manufacturing an electronic device according to an aspect of the present invention comprises a step of blowing hot air on the area to be heated, before contacting the heat generating means (which has been retracted from the area to be heated) with the area to be cheated again.

By doing so, even when the area to be heated is separated from the heat generating means, it is possible to maintain the temperature of the area to be heated at or above a predetermined value and to prevent product failures.

Furthermore, a method of manufacturing an electronic device according to an aspect of the present invention comprises steps of: transporting a first area to be heated of the continuous body onto a first heat generating means and transporting a second area to be heated of the continuous body onto a second heat generating means which has a higher temperature than the first heat generating means; and raising the temperature of the first area to be heated by contacting the first area to be heated, which has been transported onto the first heat generating means, with the first heat generating means and raising the temperature of the second area to be heated to a higher temperature than the first area to be heated by contacting the second area to be heated, which has been transported onto the second heat generating means, with the second heat generating means.

Accordingly, by transporting the continuous body, it is possible to raise the temperature of the plurality of areas to be heated simultaneously step-by-step and rapidly carry out the reflow process while suppressing thermal damage in the reflow process.

Furthermore, in a method of manufacturing an electronic device according to an aspect of the present invention, the first heat generating means and the second heat generating means are arranged in parallel in the transport direction of the continuous body such that the first heat generating means is upstream (i.e., at a former stage) of the second heat generating means relative to the direction of transportation of the continuous body.

As a result, when transporting the continuous body, it is possible to contact the plurality of areas to be heated with the plurality of heat generating means at one time which have different predetermined temperatures, and it is possible to raise the temperatures of a plurality of areas to be heated step-by-step simultaneously without movement of the heat generating means.

For this reason, it is possible to shorten the tact time of the reflow process while preventing sudden variations in temperature of the area to be heated and efficiently carry out the reflow process while maintaining product quality.

Furthermore, a method of manufacturing an electronic device according to an aspect of the present invention comprises a step of retracting the second heat generating means from the second area to be heated while keeping the first heat generating means in contact with the first area to be heated, during or after the heating of the area to be heated by the first and second heat generating means.

By doing so, even when a transport system is stopped during the heating of the plurality of areas to be heated, it is possible to rapidly avoid thermal damage on the second area to be heated while maintaining the temperature of the first area to be heated constant and, even when the heating conditions of the areas to be heated are different from each other, it is possible to suppress the deterioration of the quality in the reflow process.

Furthermore, a method of manufacturing an electronic device according to an aspect of the present invention comprises a step of contacting the second heat generating means that was retracted from the second area to be heated with the second area to be heated again.

By doing so, even when the second heat generating means is retracted from the second area to be heated in order to avoid thermal damage thereon, it is possible to restore the second area to be heated to the original temperature without affecting the temperature of the first area to be heated, and resume the reflow process without product failures.

Furthermore, a method of manufacturing an electronic device according to an aspect of the present invention comprises a step of blowing hot air onto the second area to be heated, before re-contacting the second heat generating means that was separated from the second area to be heated with the second area to be heated.

By doing so, even when the second area to be heated is separated from the second heat generating means in order to avoid thermal damage thereon, it is possible to maintain the temperature of the second area to be heated at or above a predetermined value and prevent product failures.

Furthermore, a method of manufacturing an electronic device according to an aspect of the present invention further comprises a step of sliding a supporting stand for supporting the heat generating means in the transport direction of the continuous body such that the heat generating means is positioned to correspond to a product pitch.

By doing so, it is possible to match the position of the heat generating means to the product pitch while confirming the match by the naked eye and, even when the product pitches are different from each other, it is possible to maintain uniformity in heating time.

Furthermore, a method of manufacturing an electronic device according to an aspect of the present invention comprises a step of lowering the temperature of the area to be heated, after its temperature was raised by the heat generating means.

By doing so, it is possible to rapidly lower the temperature of the area to be heated, thereby improving the solder wettability and stabilizing the bonding. In addition, it is possible to prevent the area to be heated from exposure to a high temperature for a long time and prevent thermal oxidation of the solder.

Furthermore, in a method of manufacturing an electronic device according to an aspect of the present invention, by contacting an area or member having a lower temperature than the heat generating means with at least a part of the area to be heated, which had its temperature raised by the heat generating means, the temperature of the area to be heated may be lowered.

By doing so, it is possible to control the cooling condition of the area to be heated by using conductive heat, to improve the cooling efficiency and shorten the cooling time. For this reason, it is possible to shorten the tact time in the cooling process, suppress thermal oxidation of the solder and deterioration of the product quality, and efficiently carry out the reflow process.

Furthermore, in a method of manufacturing an electronic device according to an aspect of the present invention, the lower temperature area is arranged at a previous or subsequent stage of the heat generating means or between heat generating means that are in parallel.

Accordingly, when transporting the continuous body, it is possible to contact the area to be heated with the lower temperature area which has a lower temperature than the heat generating means and to efficiently carry out the cooling in the reflow process.

Furthermore, by arranging in parallel the lower temperature area which has a lower temperature than the heat generating means at a previous stage of the heat generating means or between two heat generating means, it is possible to shield the heat generated by the heat generating means at the boundary of the heat generating means, definitely maintain the boundary temperature of the heat generating means and improve the product quality in the reflow process.

Furthermore, in a method of manufacturing an electronic device according to an aspect of the present invention, by blowing a gas against one or both surfaces of the area to be heated, which had its temperature raised by the heat generating means, the temperature of the area to be heated is lowered.

By doing so, even when an electronic component has been mounted on the area to be heated, it is possible to distribute the coolant uniformly in every corner of the area to be heated and efficiently lower the temperature of the area to be heated.

Furthermore, a program for manufacturing an electronic device according to an aspect of the present invention makes a computer execute a step of raising the temperature of an area to be heated by controlling the distance between the area to be heated of a continuous body in which an electronic component mounting area is provided on each of a plurality of circuit blocks and heat generating means.

Accordingly, by installing the program for manufacturing an electronic device, it is possible to definitely control the distance between the area to be heated of the continuous body and the heat generating means, and efficiently manufacture electronic devices while suppressing thermal damage in the reflow process.

### BRIEF DESCRIPTION OF THE DRAWINGS

FIG. 1 is a view illustrating a method of manufacturing an electronic device according to the first embodiment of the present invention.

FIG. 2 is a view illustrating an apparatus for manufacturing an electronic device according to a second embodiment of the present invention.

FIGS. 3(a) to (e) are views illustrating a reflow process of FIG. 2.

FIG. 4 is a view illustrating the reflow process of FIG. 2.

FIG. 5 is a view illustrating a temperature profile of the reflow process of FIG. 2.

FIG. 6 is a view illustrating an apparatus for manufacturing an electronic device according to a third embodiment of the present invention.

FIGS. 7(a) to (e) are views illustrating a reflow process of FIG. 6.

FIGS. 8(a) and (b) are views illustrating a method for manufacturing an electronic device according to a fourth embodiment of the present invention.

FIGS. 9(a) to (c) are views illustrating a method of manufacturing an electronic device according to the fourth embodiment of the present invention.

FIGS. 10(a) to (c) are views illustrating a method of manufacturing an electronic device according to a fifth embodiment of the present invention.

FIGS. 11(a) and (b) are views illustrating a method of manufacturing an electronic device according to a sixth embodiment of the present invention.

FIG. 12 is a view illustrating an apparatus for manufacturing an electronic device according to a seventh embodiment of the present invention.

FIGS. 13(a) to (f) are views illustrating a reflow process of FIG. 12.

FIG. 14 is flowchart illustrating the reflow process of FIG. 12.

FIG. 15 is a view illustrating an apparatus for manufacturing an electronic device according to an eighth embodiment of the present invention.

FIGS. 16(a) to (c) are views illustrating an apparatus for manufacturing an electronic device according to a ninth embodiment of the present invention.

FIG. 17 is a view illustrating the conventional method of manufacturing an electronic device.

### DETAILED DESCRIPTION

An apparatus for manufacturing an electronic device and a method for manufacturing an electronic device in accordance with embodiments of the present invention will be described with reference to the drawings.

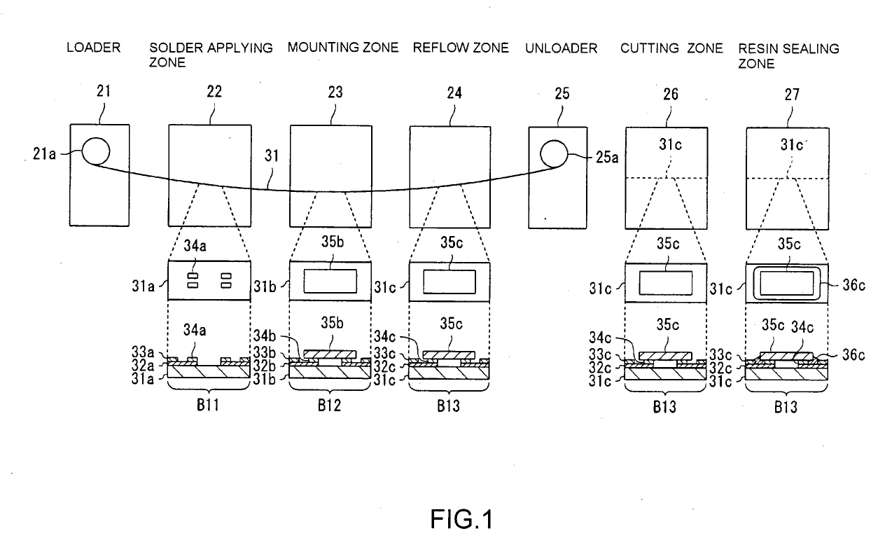

FIG. 1 is a view illustrating a method for manufacturing an electronic device in accordance with a first embodiment of the present invention.

In FIG. 1, a solder applying zone 22, a mounting zone 23, and a reflow zone 24 are sequentially aligned in the transport direction of a tape substrate 31 between a loader 21 and an unloader 25.

In addition, on the tape substrate 31, an electronic component mounting area is provided on respective circuit blocks B11 to B13, and the circuit blocks B11 to B13 are provided with circuit substrates 31a to 31c, respectively. Wirings 32a to 32c are formed on each circuit substrate 31a to 31c, respectively, and insulating films 33a to 33c are formed on the wirings 32a to 32c, respectively, such that terminal portions of the wirings 32a to 32c are exposed,.

The tape substrate 31, on which the circuit substrates 31a to 31c each having predetermined lengths are sequentially arranged, is laid (i.e., extends) between an unwinding reel 21a and a take-up reel 25a. In each transport tact of the tape substrate 31, a solder non-applied zone of the tape substrate 31 is transported to the solder applying zone 22 provided between the loader 21 and the unloader 25, a solder applying-finished zone of the tape substrate 31 is transported to a mounting zone 23 arranged next to the solder applying zone 22, and a mounting-finished area of the tape substrate 31 is transported to a reflow zone 24 arranged next to the mounting zone 23.

Therefore, a solder paste 34a is printed on the circuit substrate 31a in the solder applying zone 22, a semiconductor chip 35b is mounted on the circuit substrate 31b on which the solder paste 34b has been printed, in the mounting zone 23, and in the reflow zone 4 a reflow process is performed for the circuit substrate 31c on which a semiconductor chip 35c has been mounted, and the semiconductor chip 35c is fixed on the circuit substrate 31c through a solder paste 34c.

When the solder applying process, the mounting process and the reflow process for all the circuit blocks B11 to B13 are finished, the tape substrate 31 is cut into respective circuit blocks B11 to B13 in a cutting zone 26. Further, each of the cut circuit blocks B11 to B13 is moved into a resin sealing zone 27, and, for example, by applying a sealing resin 36c to circumferential portions of the semiconductor chip 35c, the circuit block B13 can be resin-sealed.

Accordingly, by transporting the tape substrate 31 only one time between the unwinding real 21a and the take-up real 25a, it is possible to complete the solder applying process, the mounting process and the reflow process for the circuit substrates 31a to 31c. It is also possible to simultaneously perform the solder applying process, the mounting process and the reflow process respectively on different circuit substrates 31a to 31c, thereby improving production efficiency.

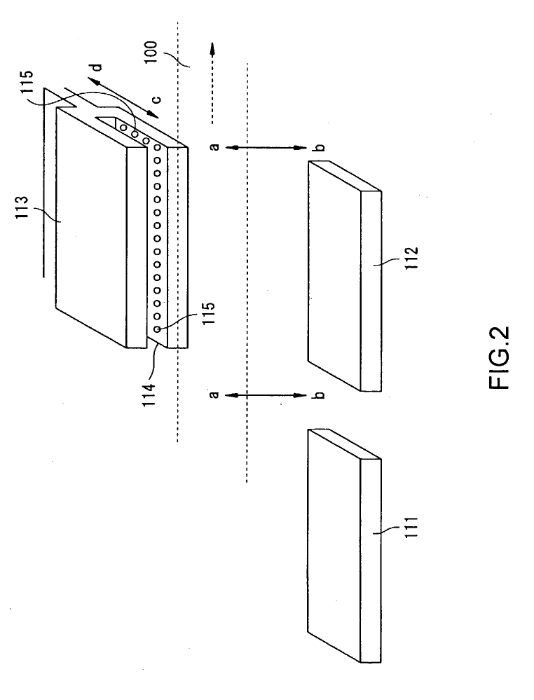

FIG. 2 is a prospective view illustrating the schematic structure of an apparatus for manufacturing an electronic device according to a second embodiment of the present invention.

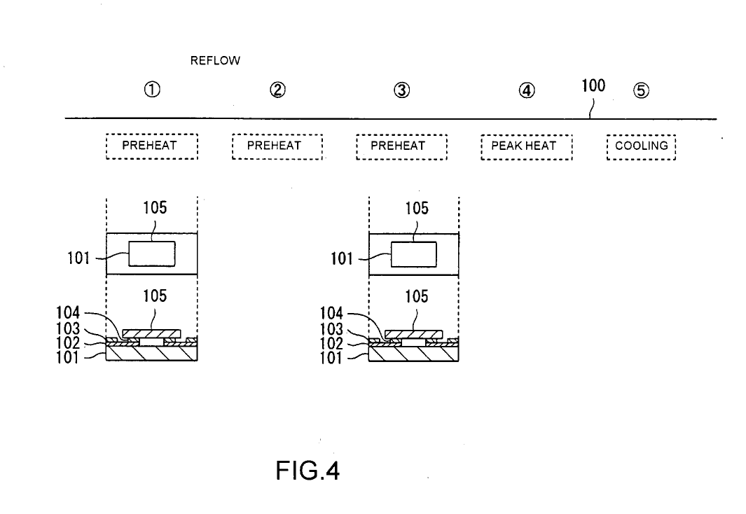

In FIG. 2, there are provided a preheating block 111 used to apply preheat, a main heating block 112 used to apply peak heat and a cooling block 113 used to lower the temperature of a body to be heated to which the peak heat has been applied, and for example, in the reflow process to be carried out after the soldering process and the mounting process, heating or cooling is carried out on a tape substrate 100, i.e., a continuous body on which circuit substrates 101 as bodies to be heated as shown in FIG. 4, each having a predetermined block length, are sequentially arranged.

The preheating block 111 is made of a metal, ceramic or the like and is movable in the directions indicated by arrows a and b by means of a driving mechanism (not shown). The preheating block 111 slowly reaches the tape substrate 100 to apply the preheat, and the details thereof will be described later.

The main heating block 112 is made of a metal, ceramic or the like and is closely arranged (or adjacent) to the preheating block 111. Further, the main heating block 112 is movable in the directions indicated by arrows a and b by means of a driving mechanism not shown. The main heating block 112 contacts the tape substrate 100 to apply the peak heat, and the details thereof will be described later.

The cooling block 113 is made of, for example, a metal, ceramic or the like, and is movable in the directions indicated by arrows c and d by means of a driving mechanism (not shown). The cooling block 113 has a covering and sandwiching opening 114 with a U-shaped cross-section selectively covering and sandwiching the top and bottom of the tape substrate 100 (from the upper and lower sides of the tape substrate 100 in its thickness direction). The inner surface of the covering and sandwiching opening 114, a plurality of coolant blowout holes 115 are provided. Air, oxygen, nitrogen, carbon dioxide, helium, fluorocarbon or similar gases can be employed as the coolants to be emitted from the holes 115, for example.

Here, on the tape substrate 100, as shown in FIG. 4, a plurality of circuit substrates 101 having a predetermined block length are arranged sequentially. In the soldering process before the reflow process, solder paste 104 is attached onto the wirings 102 on the circuit substrate 101. Further, adhesive such as ACF may be attached onto the wirings 102 through transcription. Reference numeral 104 indicates an insulating film. In the mounting process after the soldering process, a semiconductor chip 105 is mounted on the circuit substrate 101 though the solder paste 104.

If the production line between the loader 21 and the unloader 25 described in FIG. 1 is stopped during the heating by the preheating block 111 or the main heating block 112 for any reason, it is possible to avoid over heating of the tape substrate 100. This is accomplished by separating the preheating block 111 or the main heating block 112 from the tape substrate 100.

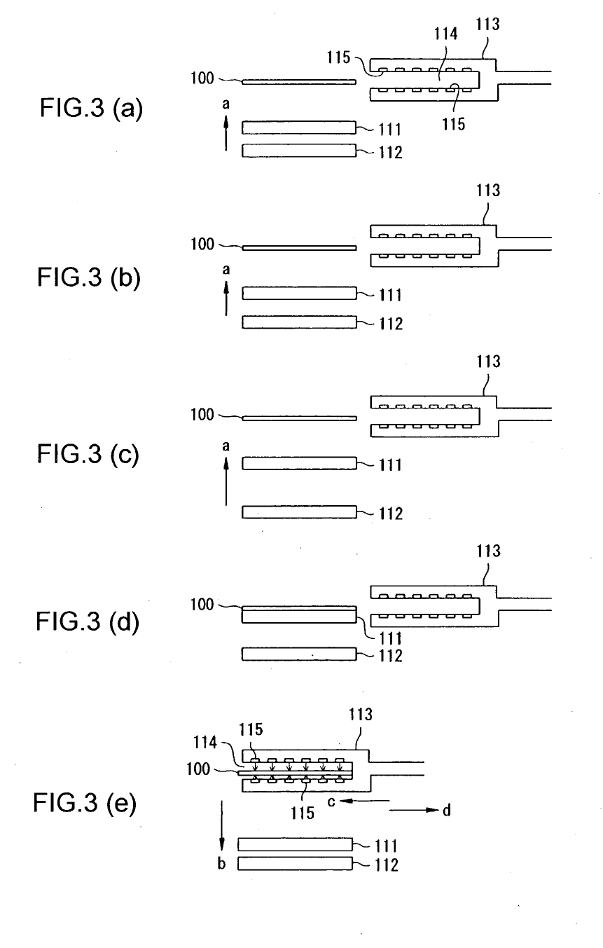

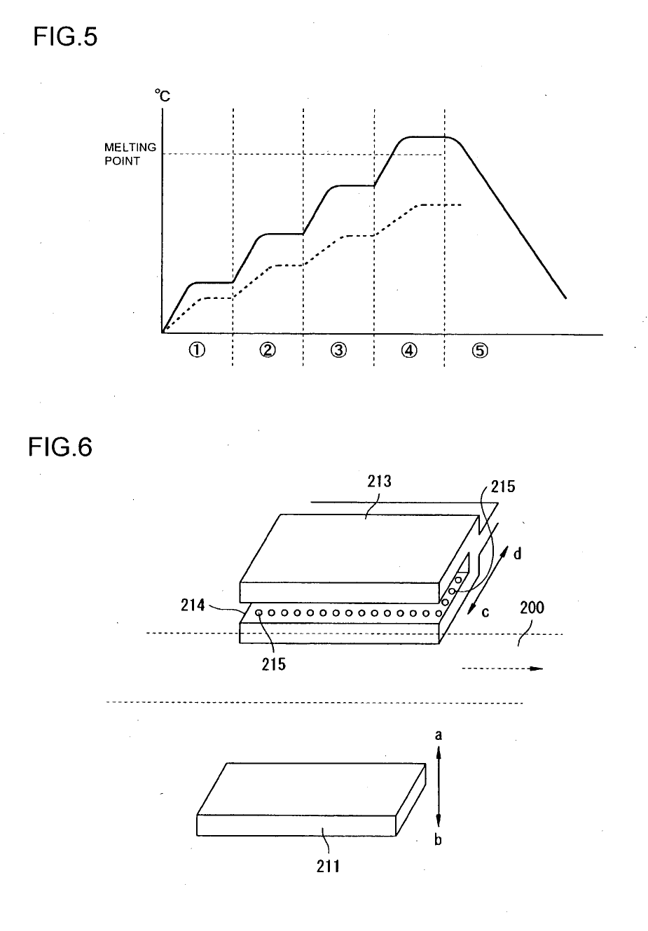

FIGS. 3 and 4 are views illustrating the reflow process in FIG. 2, and FIG. 5 is a view illustrating the temperature profile in the reflow process in FIG. 2.

In FIGS. 3 to 5, when the tape substrate 100 on which the soldering process and the mounting process have been completed proceeds to the reflow process, the preheating block 111 approaches the tape substrate 100 by moving up by one incremental step in the direction of arrow a, as shown in FIG. 3(a). At that time, the main heating block 112 is held at a predetermined position.

Therefore, the preheating block 111 approaches the circuit substrate 101 having the predetermined block length in the tape substrate 100 shown in FIG. 4 for a predetermined interval of time to carry out the heating. By doing so, the preheat (1) is applied to the circuit substrate 101. The preheat (1) has the gradient of temperature indicated by the solid line in region (1) of FIG. 5.

If the heating in FIG. 3(a) by the preheating block 111 is completed, the preheating block 111 moves up by another incremental step in the direction of arrow a, as shown in FIG. 3(b), to approach the tape substrate 100, and as described above, carries out the heating of the circuit substrate 101 for a predetermined time. By doing so, the preheat (2) is applied to the circuit substrate 101, as shown in FIG. 4. The preheat (2) has the gradient of temperature indicated by the solid line in region (2) of FIG. 5.

If the heating in FIG. 3(b) by the preheating block 111 is completed, the preheating block 111 moves up by another incremental step in the direction of arrow a, as shown in FIG. 3(c) to approach the tape substrate 100, and as described above, carries out the heating on the circuit substrate 101 for a predetermined time. By doing so, the preheat (3) is applied to the circuit substrate 101, as shown in FIG. 4. The preheat (3) has the gradient of temperature indicated by the solid line in region (3) of FIG. 5. Further, when the preheats (1) to (3) are applied to the circuit substrate 101 by the preheating block 111, since the main heating block 112 is held at the predetermined position, the effect of the heat transferred from the main heating block 112 to the circuit substrate 101 is avoided.

If the heating in FIG. 3(c) by the preheating block 111 is completed, the preheating block 111 is restored to the predetermined position, as shown in FIG. 3 (d). At that time, the tape substrate 100 is transported in the direction indicated by the dotted arrow of FIG. 2 only by the predetermined block length of the circuit substrate 101. Then, the main heating block 112 moves up to contact with the tape substrate 100 and carries out the heating of the circuit substrate 101 for a predetermined time. By doing so, the peak heat (4) is applied to the circuit substrate 101, as shown in FIG. 4. The peak heat (4) has the gradient of temperature indicated by the solid line in region (4) of FIG. 5. Since the peak heat (4) is the solder melting point temperature +α, the solder paste 104 is melted and the semiconductor chip 105 is bonded to the wirings 102 on the circuit substrate 101.

When the heating in FIG. 3(d) by the preheating block 111 is completed, the main heating block 112 moves in the direction of arrow b to return to the predetermined position, as shown in FIG. 3(e), and the cooling block 113 moves in the direction of arrow c from the predetermined position shown in FIG. 3(a) to cover and sandwich the tape substrate 100 along the upper and lower sides thereof by using the covering and sandwiching opening 114.

Then coolant is sprayed from the plurality of coolant blowout holes 115 provided on the inner surface of the covering and sandwiching opening 114 on the upper and lower surfaces of the circuit substrate 101, so that the circuit substrate 101 is cooled.

By doing so, the circuit substrate 101 is cooled as indicated in (5) of FIG. 4. The cooling process (5) has the gradient of temperature indicated by the solid line in region (5) of FIG. 5. By cooling the circuit substrate 101 like this, the semiconductor chip 105 is fixed to the circuit substrate 101 through the wirings 102. When the cooling of the circuit substrate 101 for a predetermined time is complete, the cooling block 113 moves in the direction of arrow d from the position shown in FIG. 3(e) to return to the predetermined position of FIG. 3(a).

According to the above process, when the preheat, the peak heat and the cooling are sequentially applied to the circuit substrate 101 having a predetermined block length of the tape substrate 100 and then the reflow process of circuit substrate 101 is completed, the tape substrate 100 is transported by the predetermined block length of the circuit substrate 101 and the preheat, the peak heat and the cooling are sequentially applied to the next circuit substrate 101 as shown in FIGS. 3(a) to (e), so that the reflow process of the next circuit substrate 101 is carried out.

Furthermore, if the production line between the loader 21 and the unloader 25 described referring to FIG. 1 is stopped for any reason while the heating is being carried out by the preheating block 111 or the main heating block 112, the preheating block 111 or the main heating block 112 is separated from the tape substrate 100. Accordingly, it is possible to avoid over heating of the tape substrate 100.

On the other hand, after the stopped production line is restored, the preheat, the peak heat and the cooling are applied again. At that time, when the temperature of the circuit substrate 101 having a predetermined block length in the tape substrate 100 has been lowered, for example, as indicated by the dotted line of regions (1) to (4) in FIG. 5, the preheating block 111 first moves up slowly in correspondence to (1) to (3) respectively, and thus the temperature of the circuit substrate 101 having a predetermined block length of the tape substrate 100 is raised to a position indicated by the solid line in FIG. 5. Next, by contacting the main heating block 112 with the circuit substrate 101, the peak heat can be applied. Therefore, after restoration of the line, the reflow process can be resumed without damaging the products thereon.

In this way, in the second embodiment, the preheating block 111 slowly goes up from the predetermined position to approach the circuit substrate 101 having the predetermined block length of the tape substrate 100 to apply the preheat and, then returns to the predetermined position. The main heating block 112 arranged closely to the preheating block 111 contacts the circuit substrate which has been subjected to the preheating and is transported by a predetermined tact, to apply the peak heat thereto and is then restored to the predetermined position. The cooling block 113 is made to approach the circuit substrate 101 to which the peak heat has been applied, to cool the circuit substrate 101 and is then restored to the predetermined position.

By doing so, since the boundary temperature between the preheating block 111 and the main heating block 112 can be definitely maintained, it is possible to easily control product quality. Further, since the light-shielding structure of the conventional lamp heating method or far-infrared ray method is not required, it is possible to simplify the construction of the apparatus.

Furthermore, if the line from the loader 21 to the unloader 25 described referring to FIG. 1 is stopped, for example, when heating is being carried out by the preheating block 111 or the main heating block 112, the preheating block 111 or the main heating block 112 is separated from the tape substrate 100. As a result, it is possible to avoid over heating of the tape substrate 100 and easily control product quality.

On the other hand, after the stopped line is restored, if the temperature of the circuit substrate 101 having the predetermined block length of the tape substrate 100 is lowered, for example, as indicated by the dotted line of (1) to (4) in FIG. 5, the preheating block 111 first moves up slowly in correspondence to (1) to (3), respectively, to make the temperature of the circuit substrate 101 having the predetermined block length of the tape substrate 100 rises to a position indicated by the solid line in FIG. 5. Next, by contacting the main heating block 112 with the circuit substrate 101, the peak heat can be applied again, and the circuit substrate 101 to which the peak heat is applied is cooled again by the cooling block 113. As a result, the reflow process can be resumed without damaging the products thereon.

Furthermore, since the preheat, the peak heat and the cooling are applied again after the stopped line is restored,, it is possible to significantly shorten the waiting time for the heating or the cooling after the line is restored.

Furthermore, since the circuit substrate 101 to which the peak heat has been applied is cooled by means of the coolant from the plurality of coolant blowout holes 115 in the covering and sandwiching opening 114 of the cooling block 113, it is possible to improve the cooling efficiency of the circuit substrate 101. As a result, since the cooling time is shortened, it is possible to easily prevent thermal oxidation of the solder, even when the solder paste 104 is lead-free.

In the present embodiment, although the preheating block 111 was described as being raised step-by-step to apply the preheat, it is not limited to this example and the preheating block may be raised linearly to apply the preheat.

Further, in the present embodiment, although it has been described that the preheating block 111 and the main heating block 112 move upward from the lower side of the tape substrate 100, it is not limited to this example and they may move downward from the upper side of the tape substrate 100. Furthermore, in the present embodiment, although it has been described that the covering and sandwiching opening 114 having a U-shaped cross-section and having the plurality of coolant blowout holes 115 is provided in the cooling block 113, it is not limited to this and the cooling block 113 may have a flat plate shape and may have the coolant blowout holes 115 on the side facing the tape substrate 100. Furthermore, the present embodiment has been described in the case that one preheating block 111 is provided, however, it is not limited to this and a plurality of preheating blocks 111 may be provided.

FIG. 6 is a view illustrating a schematic construction of an apparatus for manufacturing an electronic device in accordance with a third embodiment of the present invention.

In FIG. 6, a heating block 211 for applying heat and a cooling block 213 for lowering the temperature of the body to be heated to which the heat has been applied, and, for example, in the reflow process after the soldering process and the mounting process, the heating and the cooling can be carried out on the tape substrate 200 as a continuous body on which the circuit substrates as bodies to be heated having a predetermined block lengths are arranged. Further, as the circuit substrate to be arranged in the tape substrate 200, for example, the same construction as in FIG. 4 can be employed.

The heating block 211 is made of, for example, a metal, ceramic or the like and is movable by means of a driving mechanism (not shown) in the directions of arrows a and b. The heating block 211 slowly approaches the tape substrate 200 to apply the preheat and also contacts the tape substrate 200 to apply the peak heat, but details thereof will be described later.

The cooling block 213 is made of, for example, a metal, ceramic or the like and is movable by means of a driving mechanism (not shown) in the directions of arrows c and d. The cooling block 213 has a covering and sandwiching opening 214 having a U-shaped cross-section to cover and sandwich the tape substrate 200 from the upper and lower sides thereof in the thickness direction. A plurality of coolant blowout holes 215 are provided on the inner surface of the covering and sandwiching opening 214.

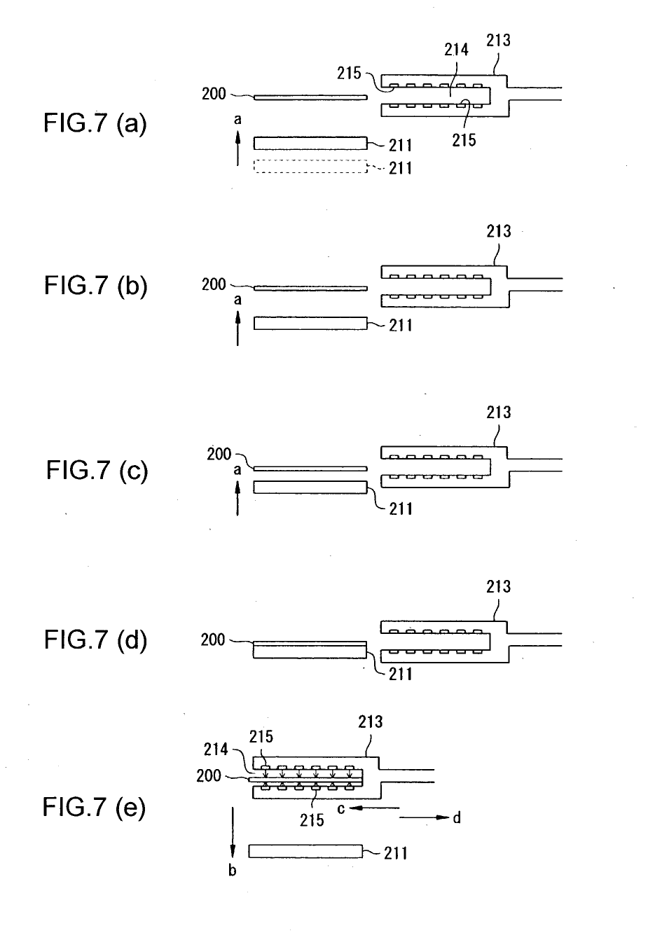

FIG. 7 is a side view illustrating the reflow process in FIG. 6.

In FIG. 7, when the tape substrate 200 having been subjected to the soldering process and the mounting process moves to the reflow process, as shown in FIG. 7(a), the heating block 211 moves up by one incremental step from the initial position in the direction of arrow a indicated in phantom to approach the tape substrate 200.

At that time, the heating block 211 approaches on the circuit substrate having a predetermined block length of the tape substrate 200 to perform the heating. By doing so, the same preheat (1) as in FIG. 4 is applied to the circuit substrate. The preheat (1) may have the gradient of temperature indicated by the solid line in region (1) of FIG. 5.

When the heating process in FIG. 7(a) by the heating block 211 is completed, the heating block 211 moves up by another incremental step in the direction of arrow a as shown in FIG. 7(b) to approach the tape substrate 200 and as described above, the heating process for a predetermined interval of time is carried out on the circuit substrate. By doing so, the same preheat (2) as in FIG. 4 is applied to the circuit substrate. The preheat (2) may have the gradient of temperature indicated by the solid line in region (2) of FIG. 5.

When the heating process in FIG. 7(b) by the heating block 211 is completed, the heating block 211 moves up by another incremental step in the direction of arrow a as shown in FIG. 7(c) to approach the tape substrate 200 and as described above, the heating process for a predetermined time is carried out on the circuit substrate. By doing so, the same preheat (3) as in FIG. 4 is applied to the circuit substrate. The preheat (3) may have the gradient of temperature indicated by the solid line in region (3) of FIG. 5.

When the heating process in FIG. 7 (c) by the heating block 211 is completed, the heating block 211 moves up by yet another incremental step in the direction of arrow a as shown in FIG. 7(d) to contact the tape substrate 200 and as described above, the heating process for a predetermined time is carried out on the circuit substrate. By doing so, the same peak heat (4) as in FIG. 4 is applied to the circuit substrate. The peak heat (4) may have the gradient of temperature indicated by the solid line in region (4) of FIG. 5. Here, since the peak heat (4) is the soldering melting point temperature +α, the solder paste is melted, and the semiconductor chip is bonded to the wirings on the circuit substrate.

When the heating process in FIG. 7(d) by the heating block 211 is completed, as shown in FIG. 7(e), the heating block 211 moves down in the direction of arrow b to return to the initial position, and the cooling block 213 moves in the direction of arrow c from the initial position shown in FIG. 7(a) to cover and sandwich the tape substrate 200 from the upper and lower sides thereof with the covering and sandwiching opening 214.

Then, coolant from the plurality of coolant blowout holes 215 provided on the inner surface of the covering and sandwiching opening 214 is sprayed onto the upper and lower surfaces of the circuit substrate, so that the circuit substrate is cooled.

By doing so, the circuit substrate is cooled as in (5) in FIG. 4. The cooling (5) may have the temperature gradient indicated by the solid line in region (5) of FIG. 5. By cooling the circuit substrate like this, the semiconductor chip is fixed to the circuit substrate though the wirings. When the cooling process on the circuit substrate for a predetermined time is completed, the cooling block 213 moves in the direction of arrow d from the condition in FIG. 7(e) and returns to the initial position in FIG. 7(a).

As described above, after completion of the reflow process of a certain circuit substrate having a predetermined block length of the tape substrate 200 by sequentially applying the preheat, the peak heat and the cooling thereto, the tape substrate 200 is transported only by the predetermined block length of the next circuit substrate. As shown in FIGS. 7(a) to (e), by sequentially applying the preheat, the peak heat and the cooling, the reflow process is carried out on a next circuit substrate.

Furthermore, if the production line from the loader 21 to the unloader 25 described in FIG. 1 is stopped while the heating is being carried out by the heating block 211, the heating block 211 is separated from the tape substrate 200. As a result, it is possible to avoid over heating of the tape substrate 200.

On the other hand, when the stopped line is restored, the preheat, the peak heat and the cooling are applied again. At that time, when the temperature of the circuit substrate having a predetermined block length of the tape substrate 200 is lowered, for example, as indicated by the dotted line of (1) to (4) in FIG. 5, the heating block 211 moves up slowly in correspondence to (1) to (4), and thus the temperature of the circuit substrate having a predetermined block length of the tape substrate 200 is raised to a position indicated by the solid line in FIG. 5. Therefore, after restoration of the line, the reflow process can be resumed without damaging the products thereon.

In this way, in the third embodiment, the heating block 211 slowly goes up from the initial position to approach the circuit substrate having the predetermined block length of the tape substrate 200 and to apply the preheat, contacts the circuit substrate to apply the peak heat, and then returns to the initial position. Thereafter, the cooling block 213 moves horizontally from the initial position to approach the circuit substrate to which the peak heating was applied and to cool the circuit substrate and then returns to the initial position. Therefore, unlike in the conventional art, a plurality of heater zones are not required, so that the space used can be reduced.

Furthermore, since the heating block 211 slowly goes up from the initial position and approaches the circuit substrate of the predetermined block length in the tape substrate 200 to carry out the preheating and contacts the circuit substrate to apply the peak heat and since the tape substrate 200 is covered and sandwiched with the covering and sandwiching opening 214 in cooling block 213 and the circuit substrate is cooled by the coolant from the plurality of coolant blowout holes 215 provided on the inner surface of the covering and sandwiching opening 214, the heating efficiency and the cooling efficiency on the circuit substrate are improved. Therefore, it is possible to shorten the time required for the heating and the cooling, and to save energy.

Furthermore, if the line from the loader 21 to the unloader 25 described in FIG. 1 is stopped, since the heating block 211 is separated from the tape substrate 200, it is possible to avoid over heating of the tape substrate and to avoid product damage. Furthermore, after the line is restored, since the preheat, the peak heat and the cooling are applied again after the stopped line is restored, it is possible to significantly shorten the waiting time for the heating or the cooling after the line is restored.

Since the circuit substrate to which the peak heat was applied is cooled by the coolant from the plurality of coolant blowout holes 215 in the covering and sandwiching opening 214 of the cooling block 213, the cooling efficiency on the circuit substrate can be improved. As a result, since the cooling time is further shortened, it is possible to prevent thermal oxidation of the solder, even if the solder paste may be lead-free.

Furthermore, in the present embodiment, although it has been described that the heating block 211 is raised step-by-step to apply the preheat and the peak heat, it is not limited to this. For example, it is possible that the heating block contacts the circuit substrate and in this state, heat supplied from the heating block 211 is increased slowly to apply the preheating and the peak heat.

Furthermore, in the present embodiment, although it has been described that the heating block 211 is raised step-by-step to apply the preheat, it is not limited to this and the heating block may be raised linearly to apply the preheat.

Furthermore, in the present embodiment, although it has been described that the heating block 211 moves up from the lower side of the tape substrate 200, it is not limited to this example and it may move down from the upper side of the tape substrate 200.

Furthermore, in the present embodiment, although it has been described that the covering and sandwiching opening 214 having a U-shaped cross-section and having the plurality of coolant blowout holes 215 is provided in the cooling block 213, it is not limited to this example, and the cooling block 213 may have a flat plate shape and may be provided with the coolant blowout holes 215 on the side facing the tape substrate 200.

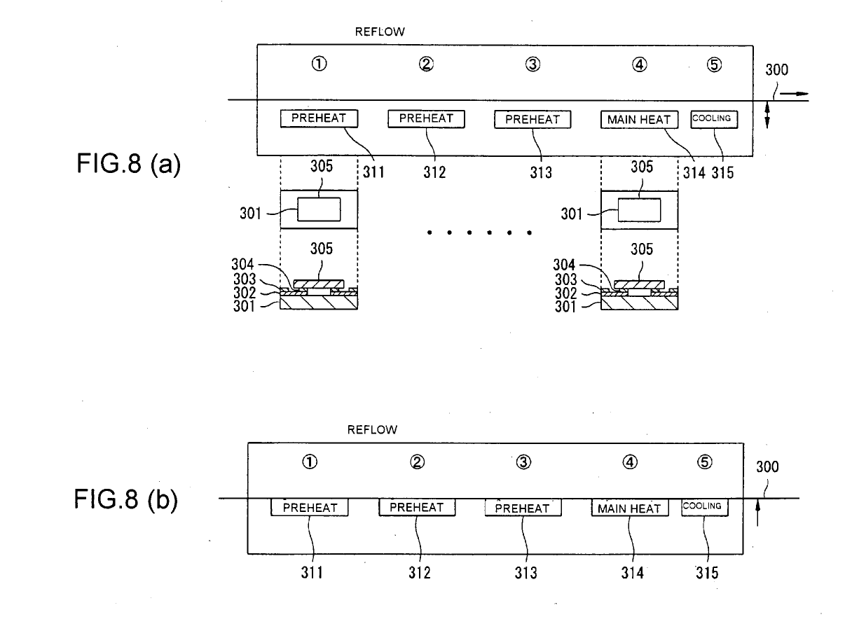

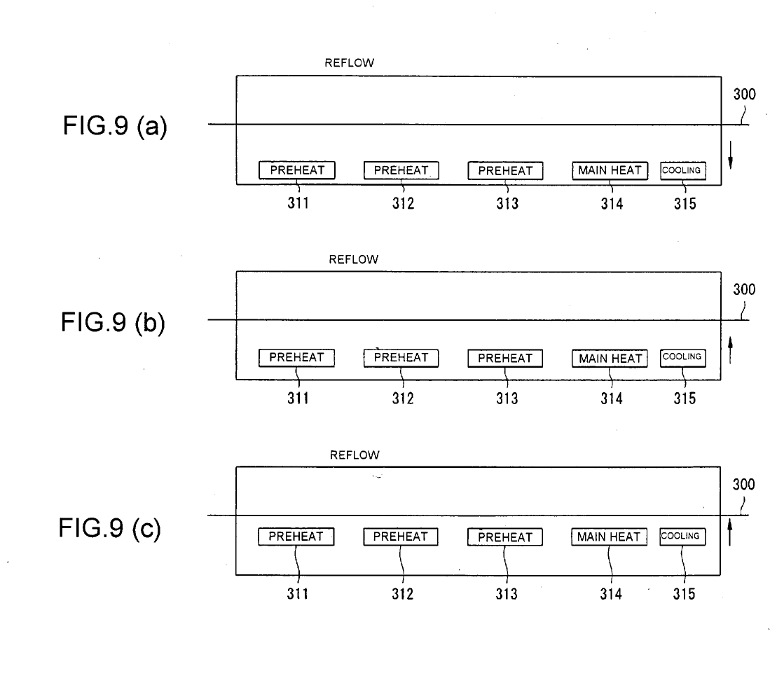

FIGS. 8 and 9 are views illustrating a method of manufacturing an electronic device in accordance with a fourth embodiment of the present invention.

In FIG. 8, preheating blocks 311 to 313 for applying the preheat, a main heating block 314 for applying the peak heat and the cooling block 315 for lowering the temperature of the body to be heated to which the peak heat was applied are provided, and in the reflow process after the soldering process and the mounting process, the heating and the cooling are carried out on a tape substrate 300, as a continuous body on which circuit substrates 301 as bodies to be heated having a predetermined block length are arranged.

The preheating blocks 311 to 313, the main heating block 314 and the cooling block 315 can be made of, for example, a metal, ceramic or the like. Further, a gap of about 2 mm, for example, can be provided between the preheating blocks 311 to 313 and the main heating block 314, respectively. This gap makes it possible to avoid direct heat conduction between the preheating blocks 311 to 313 and the main heating block 314, respectively and to move the respective blocks individually as described later.

Furthermore, the preheating blocks 311 to 313, the main heating block 314 and the cooling block 315 can move vertically. That is, when the heating or the cooling is carried out on the tape substrate 300, as shown in FIG. 8(b), the preheating blocks 311 to 313, the main heating block 314 and the cooling block 315 move up to contact the circuit substrate 301 having a predetermined block length of the tape substrate 300. The up-and-down movement of the preheating blocks 311 to 313, the main heating block 314 and the cooling block 315 may be performed together as a unit or individually. Furthermore, instead of the up-and-down movement of the preheating blocks 311 to 313, the main heating block 314 and the cooling block 315, the tape substrate 300 may be vertically moveable.

Here, the soldering process before the reflow process, a solder paste 304 is applied to a wiring 302 of the circuit substrate 301. Adhesive such as ACF may be applied onto the wiring 302 through transcription. Reference numeral 303 indicates an insulating film. In the mounting process after the soldering process, a semiconductor chip 305 is mounted on the circuit substrate 301 though the solder paste 304.

When the preheating blocks 311 to 313, the main heating block 314 and the cooling block 315 are in contact with the circuit substrate 301 of a predetermined block length in the tape substrate 300 for a predetermined time and complete the heating or the cooling, they move down and separate from the tape substrate 300. By means of these upward movements of the preheating blocks 311 to 313, the main heating block 314 and the cooling block 315 as well as the transporting of the tape substrate 300 in the direction of the horizontal arrow, the preheating, the peak heating and the cooling are sequentially carried out on the circuit substrate 301. Here, the preheating blocks 311 to 313 carry out the preheat of the tape substrate 300, as shown in regions (1) to (3) of FIG. 5. The main heating block 314 applies the peak heat of the solder melting point temperature +α, as shown in region (4) of FIG. 5. The cooling block 315, as shown in region (5) of FIG. 5, lowers the temperature of the tape substrate 300.

The manufacturing method of using the semiconductor manufacturing apparatus constructed like this will now be described.

In FIG. 8(a), the circuit substrate 301 of the tape substrate 300 having undergone the soldering process and the mounting process is transported onto the preheating blocks 311 to 313, the main heating block 314 and the cooling block 315, in the reflow process. Further, when the circuit substrate 301 of the tape substrate 300 having undergone the soldering process and the mounting process is transported onto the preheating blocks 311 to 313, the main heating block 314 and the cooling block 315, the preheating blocks 311 to 313, the main heating block 314 and the cooling block 315 move up to come in contact with the tape substrate 300. At this time, first, the preheating block 311 contacts the circuit substrate 301 of a predetermined block length in the tape substrate 300 to perform the heating for a predetermined time. As a result, the circuit substrate 301 is subjected to the preheating indicated by the solid line in region (1) of FIG. 5.

Here, when the preheating block 311 contacts with the circuit substrate 301 to perform the heating process only for a predetermined time, the circuit substrate 301 downstream of the tape substrate 300 contacts the preheating blocks 312 to 313, the main heating block 314 and the cooling block 315, so that the circuit substrate 301 downstream of the tape substrate 300 is subjected to the preheating, the peak heating and the cooling indicated by the solid lines in regions (2) to (5) of FIG. 5. For this reason, the preheating, the peak heating and the cooling by the preheating blocks 311 to 313, the main heating block 314 and the cooling block 315 can be carried out on a plurality of circuit substrate 301 arranged in the tape substrate 300 in a unit (i.e., simultaneously), and it is possible to improve production efficiency.

After completion of the heating for a predetermined time by the preheating block 311, the preheating blocks 311 to 313, the main heating block 314 and the cooling block 315 are separated from the tape substrate 300. Next, the tape substrate 300 is transported in the direction indicted by the horizontal arrow in FIG. 8(a). At this time, the transport stroke is made to correspond to the circuit substrate 301 having a predetermined block length in the tape substrate 300. When the circuit substrate 301 which has been subjected to the heating process by the preheating block 301 reaches the position of the preheating block 312, the transport of the tape substrate 300 in the right arrow direction in FIG. 8(a) is stopped, and the preheating blocks 311 to 313, the main heating block 314, and the cooling block 315 move up again. At this time, the preheating block 312 contacts the circuit substrate 301 of the predetermined block length in the tape substrate 300 to carry out the heating for a predetermined time. As a result, the circuit substrate 301 is subjected to the preheating indicated by region (2) in FIG. 5.

Here, when the preheating bock 312 contacts the circuit substrate 301 to perform the heating process only for a predetermined time, the preheating block 311 contacts the circuit substrate 301 upstream of the tape substrate 300, so that the circuit substrate 301 upstream of the tape substrate 300 is subjected to the preheating indicated by the solid line in region (1) of FIG. 5. In addition, the preheating block 313, the main heating block 314 and the cooling block 315 come into contact with the circuit substrate 301 downstream of the tape substrate 300, so that the circuit substrate 301 downstream of the tape substrate 300 is subjected to the preheating, the peak heating and the cooling indicated by the solid lines in regions (3) to (5) of FIG. 5.

After completion of the heating for a predetermined time by the preheating block 312, the preheating blocks 311 to 313, the main heating block 314 and the cooling block 315 are separated from the tape substrate 300. Next, the tape substrate 300 is transported in the direction of the right arrow in FIG. 8(a). When the circuit substrate 301 which has been subjected to the heating process by the preheating block 312 reaches the position of the preheating block 313, the transport of the tape substrate 300 in the direction of the right arrow in FIG. 8(a) is stopped, the preheating blocks 311 to 313, the main heating block 314, and the cooling block 315 move up again. At this time, the preheating block 313 contacts the circuit substrate 301 having the predetermined block length of the tape substrate 300 to carry out the heating for a predetermined time. As a result, the circuit substrate 301 is subjected to the preheating indicated by the solid line in region (3) in FIG. 5.

Here, when the preheating bock 313 contacts the circuit substrate 301 to perform the heating process only for a predetermined time, the preheating blocks 311 and 312 contact the circuit substrate 301 upstream of the tape substrate 300, so that the circuit substrate 301 upstream of the tape substrate 300 is subjected to the preheating indicated by the solid lines in regions (1) and (2) of FIG. 5. In addition, the main heating block 314 and the cooling block 315 come into contact with the circuit substrate 301 downstream of the tape substrate 300, so that the circuit substrate 301 downstream of the tape substrate 300 is subjected to the peak heating and the cooling indicated by the solid lines in regions (4) and (5) of FIG. 5.

When the heating process by the preheating block 313 for a predetermined time is completed, the preheating blocks 311 to 313, the main heating block 314 and the cooling block 315 are separated from the tape substrate 300. Next, the tape substrate 300 is transported in the direction of the right arrow in FIG. 8(a). If the circuit substrate 301 after completion of the heating process by means of the preheating block 313 reaches the position of the main heating block 314, the transport of the tape substrate 300 in the direction of the right arrow in FIG. 8(a) is stopped, the preheating blocks 311 to 313, the main heating block 314 and the cooling block 315 move up again. At this time, the main heating block 314 contacts the circuit substrate 301 of the predetermined block length in the tape substrate 300 to perform the heating process for a predetermined time. As a result, the circuit substrate 301 is subjected to the peak heating indicated by the solid line in region (4) of FIG. 5, so that the solder paste 304 is melted and the semiconductor chip 305 is attached to the wiring 302 on the circuit substrate 301.

Here, when the main heating bock 314 contacts the circuit substrate 301 to perform the heating process only for a predetermined time, the preheating blocks 311 to 313 come into contact with the circuit substrate 301 upstream of the tape substrate 300, so that the circuit substrate 301 upstream of the tape substrate 300 is subjected to the preheating indicated by the solid lines in regions (1) to (3) of FIG. 5. In addition, the cooling block 315 contacts with the circuit substrate 301 downstream of the tape substrate 300, so that the circuit substrate 301 downstream of the tape substrate 300 is subjected to the cooling indicated by the solid line in region (5) of FIG. 5.

When the heating process by the main heating block 314 for a predetermined time is completed, the preheating blocks 311 to 313, the main heating block 314 and the cooling block 315 are separated from the tape substrate 300. Next, the tape substrate 300 is transported in the direction of the right arrow in FIG. 8 (a). If the circuit substrate 301 after completion of the heating process by the main heating block 314 reaches the position of the cooling block 315, the transport of the tape substrate 300 in the direction of the right arrow in FIG. 8(a) is stopped, the preheating blocks 311 to 313, the main heating block 314 and the cooling block 315 move up again. Then, the cooling block 315 contacts the circuit substrate 301 having the predetermined block length of the tape substrate 300 to perform the cooling process for a predetermined time. As a result, the temperature of the circuit substrate 301 is lowered as indicated by the solid line in region (5) of FIG. 5, so that the semiconductor chip 305 is fixed to the circuit substrate 301 through the wiring 302.

Here, when the cooling bock 315 contacts the circuit substrate 301 to perform the cooling process only for a predetermined time, the preheating block 311 to 314 and the main heating block 314 come into contact with the circuit substrate 301 upstream of the tape substrate 300, so that the circuit substrate 301 upstream of the tape substrate 300 is subjected to the preheat and the peak heat indicated by the solid lines in regions (1) to (4) of FIG. 5.

Accordingly, through the transport of the tape substrate 300 in the direction of the right arrow in FIG. 8 (a), the circuit substrate 301 of a predetermined block length is sequentially subjected to the preheat, the peak heat and the cooling and the reflow process on the circuit substrate 301 is completed.

Furthermore, if the production line from the loader 21 to the unloader 25 described in FIG. 1 is. stopped, the preheating blocks 311 to 313, the main heating block 314 and the cooling block 315 are separated from the tape substrate 300 to a position where the temperature of the tape substrate 300 can be maintained at a level which has no negative effect on quality. As a result, it is possible to avoid over heating of the tape substrate 300.

On the other hand, when the stopped line is restored, the preheating, the peak heating and the cooling are carried out again. At this time, when the temperature of the circuit substrate 301 of a predetermined block length in the tape substrate 300 is lowered, for example, as indicated by the dotted line in FIG. 5, the temperature of the circuit substrate 301 of a predetermined block length in the tape substrate 300 is raised to the position indicated by the solid line in FIG. 5 by slowly raising the preheating blocks 311 to 313, the main heating block 314 and the cooling block 315. Therefore, after restoration of the production line, the reflow process can be resumed without damaging the products thereon. Furthermore, instead of moving up slowly, the preheating block 313, the main heating block 314 and the cooling block 315 may be adapted to move down slowly.

Further, when the stopped production line is restored, it is possible to first raise only the preheating blocks 311 to 313 to perform a predetermined preheating of the circuit substrate 301 and then to raise the main heating block 314 to perform the peak heating on the circuit substrate 301 which has been subjected to the preheating. In this case, by returning the circuit substrate 301 on the main heating block 314 onto the preheating block 313, even the circuit substrate 301 which is in the mid0course of peak heating by the main heating block 314 can be subjected to a predetermined preheating.

Accordingly, in the fourth embodiment described above, the preheating blocks 311 to 313 contact the circuit substrate 301 of a predetermined block length in the tape substrate 300 to apply the preheat of (1) to (3), the main heating block 314 contacts the circuit substrate 301 which has undergone the preheating of (3) to apply the peak heat of (4), and the cooling block 315 contacts the circuit substrate 301 on which the peak heating has been carried out to lower the temperature of the circuit substrate 301.

As described above, since the tape substrate 300 undergoes the heating process and the cooling process by contacting the preheating blocks 311 to 314, the main heating block 314 and the cooling block 315, the heating efficiency and the cooling efficiency of the tape substrate 300 can be improved and the time required for the heating process and the cooling process can be shortened, and thus the productivity can be improved. Further, since the light-shielding structure of local heating methods such as the conventional lamp heating method or the far infrared ray method, as well as the mechanism required for hot-air circulating in the conventional hot-air circulating method are not necessary, enlargement of equipment can be avoided. Furthermore, since the heating process and the cooling process by the preheating blocks 311 to 313, the main heating block 314 and the cooling block 315 can be performed individually, it is possible to easily make the process time correspond to the block length, and in addition, since heat is not exchanged between the preheating blocks 311 to 313, it is possible to definitely maintain the boundary temperature between the preheating blocks 311 to 313 and to easily control product quality.

Furthermore, if the production line from the loader 21 to the unloader 25 described in FIG. 1 is stopped, since the preheating blocks 311 to 313, the main heating block and the cooling block 315 are separated from the tape substrate 300, it is possible to avoid over heating of the tape substrate 300 and to avoid product damage. Furthermore, when the line is restored, since the preheating, the peak heating and the cooling are carried out again, it is possible to greatly shorten the waiting time for the heating or the cooling after the restoration.

Furthermore, since the cooling block 315 contacts the circuit substrate to cool the circuit substrate 301 on which the peak heating has been carried out, it is possible to improve the cooling efficiency of the circuit substrate 301. As a result, the cooling time is shortened, and even when the solder paste 214 is lead-free, it is possible to easily prevent thermal oxidation of the solder.

Furthermore, in the fourth embodiment, although it has been described that three preheating blocks 311 to 313 are provided, it is not limited to this, and less or more preheating blocks may be provided. Incidentally, when one of the preheating blocks 311 to 313 is provided, by making the preheating block slowly approach the tape substrate 300, the preheat indicated in regions (1) to (3) of FIG. 5 can be applied slowly. Furthermore, the up-and-down movement of the preheating blocks 311 to 313, the main heating block 314 and the cooling block 315 may be carried out simultaneously as a unit or individually. Furthermore, it is possible to integrate the preheating blocks 311 to 313 with the main heating block 314 as a single unit. In this case, by making one heating block slowly approach or contact the tape substrate 300, it is possible to apply the preheat indicated by the solid line in regions (1) to (3) of FIG. 5 and the peak heat indicated by the solid line in region (4) of FIG. 5.

Furthermore, in the fourth embodiment, although it has been described that the preheating blocks 311 to 313, the main heating block 314 and the cooling block 315 move up and down when the tape substrate 300 is transported in correspondence with the predetermined block length of the circuit substrate 301 in the reflow process, it is not limited to this example and the tape substrate 300 may be transported in contact with the preheating blocks 311 to 313, the main heating block 314 and the cooling block 315 which have been moved up.

Further, a hollow conduit may be provided in the interior of the cooling block 315, and cooling may be carried out while gas or liquid is flowing through the conduit. By doing so, it is possible to forcibly cool the cooling block 315 without any change of the outer shape of the cooling block 315, and improve cooling efficiency. Furthermore, as the gas flowing through the conduit provided in the cooling block 315, for example, air, oxygen, nitrogen, carbon dioxide, helium, fluorocarbon, or the like can be employed. As the liquid flowing through the conduit provided in the cooling block 315 water, oil, or the like can be employed. The interior of the conduit provided in the cooling block may be decompressed, and by doing so, the cooling efficiency can be further improved.

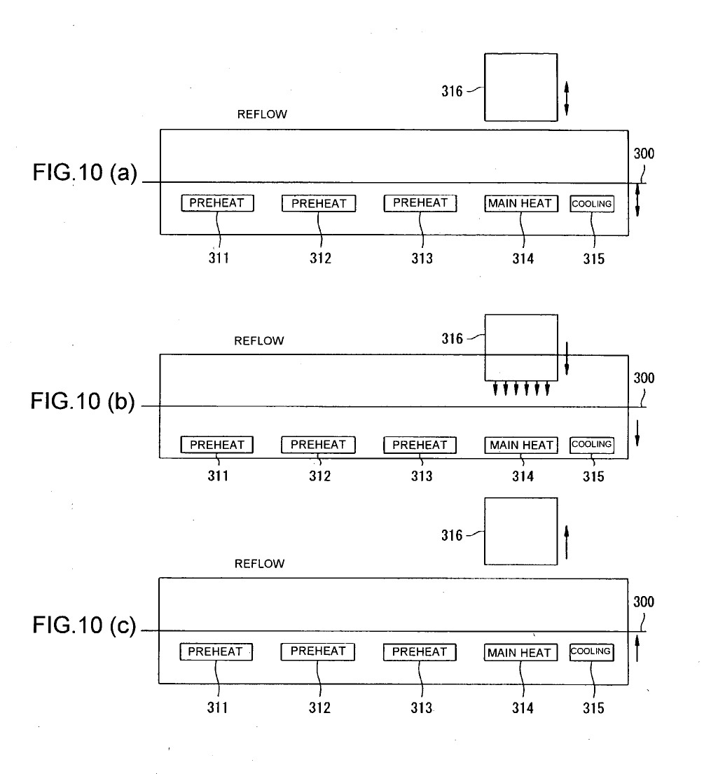

FIG. 10 is a view illustrating a method for manufacturing an electronic device in accordance with a fifth embodiment of the present invention.

In FIG. 10(a), a hot air blow block 316 is provided to supplement the preheating in addition to the structure of FIG. 8. The hot air blow block 316 is positioned above the main heating block 314, and is movable up and down by means of a driving mechanism (not shown). When the stopped production line is restored, the hot air blow block 316 moves down and approaches the tape substrate 300 to apply a predetermined preheat to the circuit substrate 301 on the main heating block 314.

The manufacturing method using the semiconductor manufacturing apparatus constructed like this will now be described.

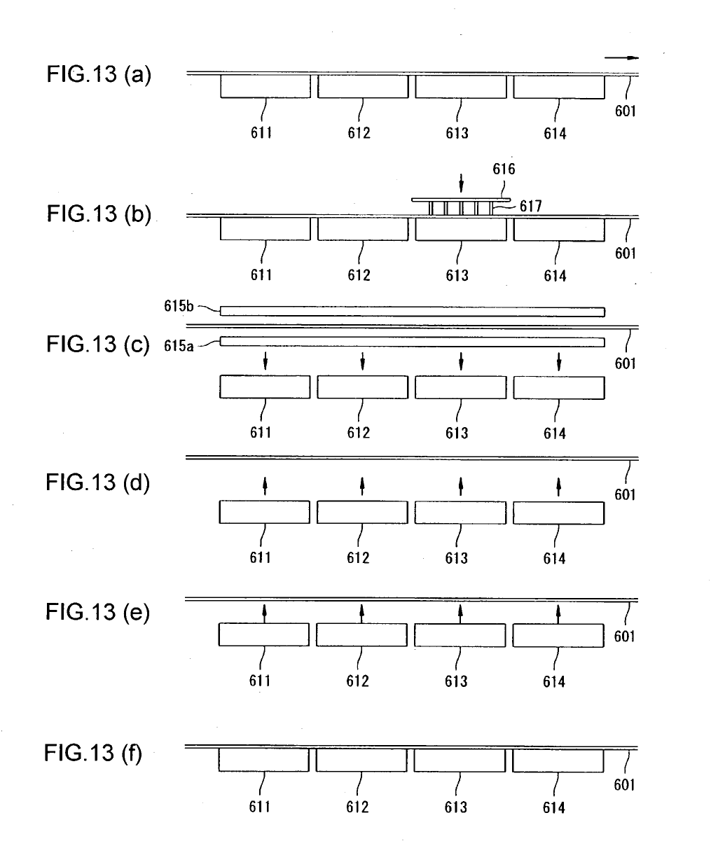

First, when the circuit substrate 301 of the tape substrate 300 which has undergone the soldering process and the mounting process proceeds to the reflow process, the preheating blocks 311 to 313, the main heating block 314, and the cooling block 315 move up to come into contact with the tape substrate 300, as shown in FIG. 13, and carry out the reflow process.

At that time, as described above, if the production line between the loader 21 and the unloader 25 described in FIG. 1 is stopped, the preheating blocks 311 to 313, the main heating block 314 and the cooling block 315 are separated from the tape substrate 300, as shown in FIG. 10(b) , by a driving mechanism (not shown) are moved to a position where the temperature of the tape substrate 300 can be maintained with no negative effect on quality. At that time, the hot air blow block 316 is moved down from above the main heating block 314 by the driving mechanism (not shown) to approach the tape substrate 300.

When the stopped production line is restored, hot air from the hot air blow block 316 is applied to the circuit substrate 301. At that time, if the temperature of the circuit substrate 301 on the main heating block 314 is lowered as indicated by the dotted line in region (4) of FIG. 5, preheating to the position indicated by the solid line in region (3) of FIG. 5 is carried out on the circuit substrate 301.

When the preheat is applied to the circuit substrate 301 on the main heating block 314, the hot air blow block 316 is moved up as shown in FIG. 10(c) by means of the driving mechanism (not shown) and is separated from the tape substrate 300. On the other hand, the preheating blocks 311 to 313, the main heating block 314, the cooling block 315 move up to come into contact with the tape substrate 300, and resume the heating and cooling processes described above. Therefore, after restoration of the line, the reflow process can be resumed without damaging the products thereon.

In this way, in the fifth embodiment described above, if the line between the loader 21 and the unloader 25 described in FIG. 1 is stopped, the preheating blocks 311 to 313, the main heating block 314 and the cooling block 315 are separated from the tape substrate 300 by means of the driving mechanism (not shown) and moved to a position where the temperature of the tape substrate 300 can be maintained at a level having no negative effect on quality, and the hot air blow block 316 is moved down by means of the driving mechanism (not shown) from above the main heating block 314 to approach the tape substrate 300, and when the stopped line has been restored, the preheating by means of the hot air from the hot air blow block 316 is carried out on the circuit substrate 301, so that it is possible to reliably avoid damage on the products when the production line is stopped, greatly shorten the waiting time for returning to normal operation after the stopped line is restored, and avoid the possible negative effects of the heat emitted from the main heating block 315 to the circuit substrate 301 on which the preheating has been carried out.

Furthermore, in the fifth embodiment described above, although it has been described in the case that the preheating blocks 311 to 313, the main heating block 314, and the cooling block 315 move up from beneath the tape substrate 300, it is not limited to this example and they may be moved from above the tape substrate 300. In this case, the hot air blow block 316 may be moved up from beneath the tape substrate 300.

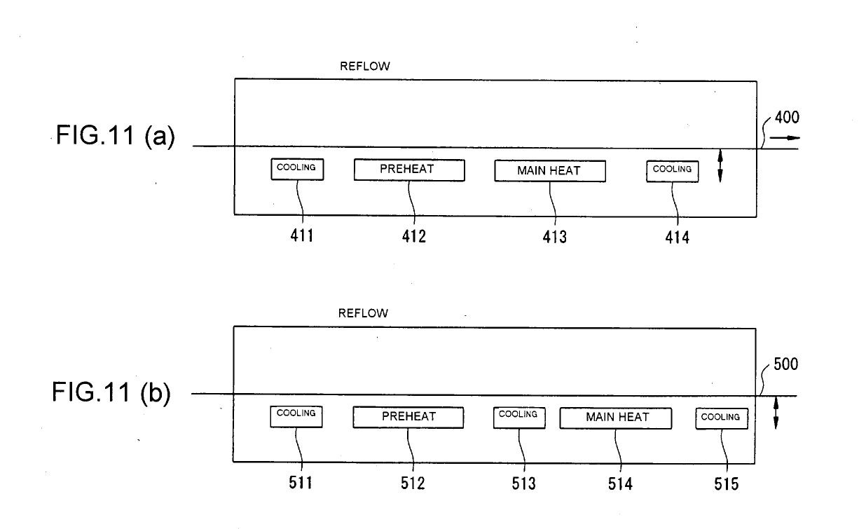

FIG. 11 is a view illustrating a method for manufacturing an electronic device in accordance with the sixth embodiment of the present invention.

In FIG. 11(a), a preheating block 412 for applying a preheat, a main heating block 413 for applying a peak heat, and a cooling block 414 for lowering the temperature of body to be heated to which the peak heat has been applied are provided, and a cooling block 411 is provided at the previous stage of the preheating block 412 for avoiding heat transfer to a tape substrate 400 before the heating process by the preheating block 412. Incidentally, in the example of FIG. 11(a), one preheating block 412 is provided for convenience of description.

In this construction, when the preheating block 412 contacts a predetermined length of a circuit substrate of the tape substrate 400 to apply the preheating of regions (1) to (3) as described in FIG. 5, the cooling block 411 contacts the predetermined length of the tape substrate 400 which has not been subject to the preheat (1). Here, since the cooling block 411 performs the cooling process of the tape substrate 400 to which the preheat (1) has not been applied to lower its temperature to about normal (i.e., room) temperature, a temperature rise of the tape substrate 400 before the heating process by the preheating block 412 can be avoided.

In this way, in the embodiment of FIG. 11(a), since the cooling block 411 contacts the predetermined length of the circuit substrate of the tape substrate 400 which has not been subjected to the preheating in FIG. 5 to cool to about normal temperature, a temperature rise of the tape substrate 400 before the heating process by the preheating block 412 can be avoided so that it is possible to easily manage product quality.

In FIG. 11(b), a preheating block 512 for applying a preheat, a main heating block 514 for applying a peak heat, and a cooling block 515 for lowering the temperature of a body to be heated to which peak heat has not been applied are provided, a cooling block 511 for preventing heat transfer to the tape substrate 500 before the heating process of the preheating block 512 is provided at the previous stage (i.e., upstream) of the preheating block 512, and a cooling block 513 for preventing heat transfer to the tape substrate 500 before the heating process by the main heating block 514 is provided between the preheating block 512 and the main heating block 514. Further, in the example of FIG. 11(b), one preheating block 512 is provided for convenience of description.

In this construction, when the main heating block 514 contacts a predetermined length of a circuit substrate of the tape substrate 500 to apply the peak heat, the cooling block 513 contacts the predetermined length of the circuit substrate of the tape substrate 500 which has not undergone the peak heating, so that a temperature rise of the tape substrate 500 before the heating process by the main heating block 514 can be avoided.

In this way, in the embodiment of FIG. 11(b), since the cooling block 513 contacts the predetermined length of the circuit substrate of the tape substrate 500 to cool it before the peak heating, a temperature rise of the tape substrate 500 before undergoing the heating process by the main heating block 514 can be avoided so that it is possible to easily control product quality.

Furthermore, in the sixth embodiment, although it has been described that one preheating block 512 is provided, it is not limited to this, and less or more preheating blocks may be provided. In case that a plurality of the preheating blocks 512 are provided, a separate cooling block may be arranged between them, and by doing so a temperature rise of a subsequent tape substrate 500 caused by applying a preheat can be avoided so that it is possible to control product quality much more easily.

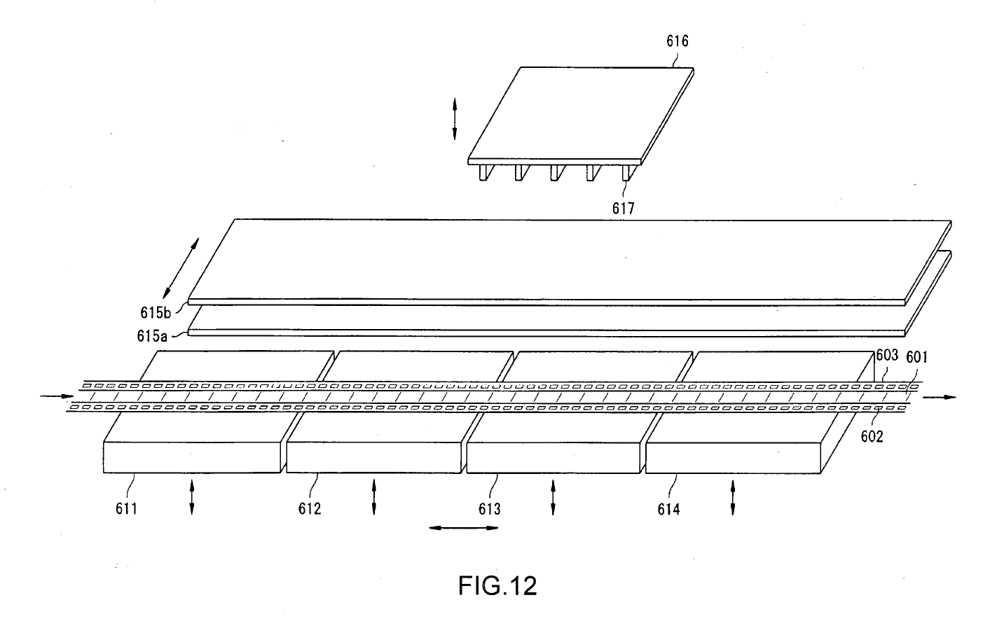

FIG. 12 is a perspective view illustrating a schematic construction of an apparatus for manufacturing an electronic device in accordance with a seventh embodiment of the present invention.

In FIG. 12, circuit blocks 603 are sequentially and longitudinally arranged on a tape substrate 601, and an electronic component mounting area is provided on every circuit block 603. Further, feed holes 602 for transferring the tape substrate 601 are provided at a predetermined pitch on both sides of the tape substrate 601. Incidentally, polyimide or the like can be used as a material for the tape substrate 601. The electronic components to be mounted on the circuit block 603 include, for example, semiconductor chips, chip condensers, resistance elements, coils and connectors.

On the other hand, in the reflow zone of the tape substrate 601, heating blocks 611 to 614 are sequentially arranged in parallel in the transport direction of the tape substrate 601 at a predetermined interval. Furthermore, a pressing plate 616 in which a downward projection 617 is provided is arranged on the heating block 613, and shutter plates 615a and 615b are arranged at the side of the heating blocks 611 to 614.

Here, the temperature of the heating blocks 611 and 612 can be set to be raised sequentially in a range lower than a solder melting point, the temperature of the heating block 613 can be set to be higher than the solder melting point and the temperature of the heating block 614 can be set to be lower than that of the heating blocks 611 and 612. Further, the heating blocks 611 to 614 and the pressing plate 616 are vertically movable independently, and the shutter plates 615a and 615b are horizontally movable in the lateral direction of the tape substrate 601, and the heating blocks 611 to 614, the shutter plates 615a and 615b and the pressing plate 616 are supported to be integrally slidable in the transport direction of the tape substrates 601. The interval between the projections 617 provided on the pressing plate 616 may be set to correspond to the length of the circuit blocks 603.

Furthermore, the heating blocks 611 to 614 and the shutter plates 615a, 615b can be made of, for example, a member containing a metal, metal compound or alloy, or ceramic. When the heating blocks 611 to 614 are made out of, for example, steel, stainless steel or the like, it is possible to suppress thermal expansion of the heating blocks 611 to 614 and to accurately transport the tape substrate 601 onto the heating blocks 611 to 614.

Furthermore, the length of each of the heating blocks 611 to 614 can be set to correspond to the lengths of a plurality of circuit blocks 603, the size of the shutter plates 615a, 615b can be set to the sum of the size of four heating blocks 611 to 614 plus the size of the gaps between the heating blocks 611 to 614, and the size of the pressing plate 616 can be set to correspond to the size of the heating block 613. In addition, it is not necessary to set the length of each of the heating blocks 611 to 614 to be an integral multiple of the size of one circuit block 603 and it is acceptable to set it to have some margin.

Furthermore, the shape of the heating blocks 611 to 614 may be set such that at least the contact surface with the tape substrates 601 is flat (i.e., planar), and for example, the heating blocks 611 to 614 can be constructed in the shape of plate.

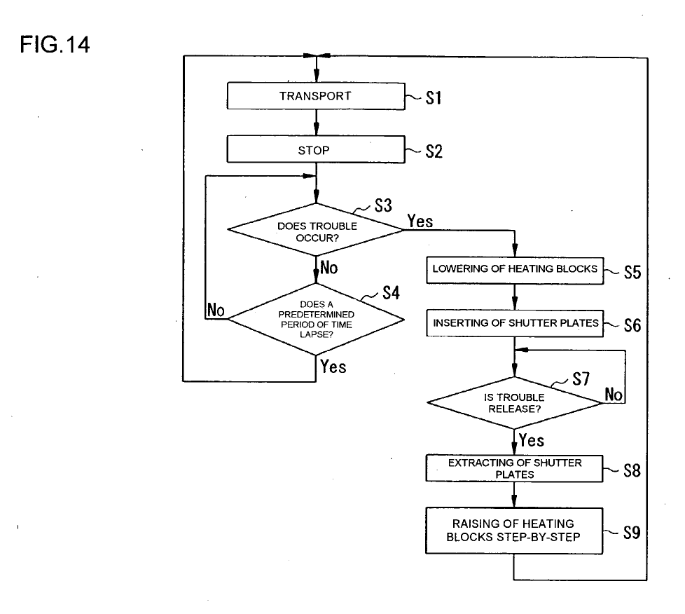

FIG. 13 is a side view illustrating the reflow process of FIG. 12, and FIG. 14 is a flow chart illustrating the reflow process of FIG. 12.

In FIGS. 13 and 14, for example, the tape substrate 601 on which the solder paste printing and the mounting process of electronic components have been carried out in the solder applying zone 22 and the mounting zone 23 in FIG. 1, is transported onto the heating blocks 611 to 614 (step S1 in FIG. 14). Furthermore, when the tape substrate 601 is transported onto the heating blocks 611 to 614, the tape substrate 601 may be transported in contact with the heating blocks 611 to 614. Accordingly, since the heating blocks 611 to 614 contact with the tape substrate 601 to perform the heating on the tape substrate 601, and it is possible to omit movement of the heating blocks 611 to 614 and to shorten the tact time in the reflow process. Here, by constructing the heating blocks 611 to 614 in the shape of plate, it is possible to transport the tape substrate 601 smoothly in contact with the heating blocks 611 to 614.

Next, as shown in FIG. 13(b), when the tape substrate 601 on which the solder paste printing and the mounting process of electronic component have been carried out is transported onto the heating blocks 611 to 614, the transport of the tape substrate 601 is stopped only for a predetermined time (steps S2 and S4 in FIG. 14), and then the tape substrate 601 is heated by means of each of the heating blocks 611 to 614. Here, the heating blocks 611 to 614 are consecutively arranged in parallel in the transport direction of the tape substrate 601, the temperature of the heating blocks 611 and 612 are set to be sequentially higher in this order within a range that is lower than the solder melting point, the temperature of the heating block 613 is set to be equal to or higher than the solder melting point, and the temperature of the heating block 614 is set to be lower than those of the heating blocks 611 and 612.

For this reason, it is possible to perform the preheating process on the circuit block 603 on the heating blocks 611 and 612, perform the main heating process on the circuit block 603, and perform the cooling process of the circuit blocks 603 on the heating block 614. Thus, it is also possible to perform the preheating, the main heating and the cooling of the respective circuit blocks 603 on the tape substrate 601 simultaneously as a unit.

Here, if the tape substrate 601 is stopped on the heating blocks 611 to 614, a pressing plate 616 moves down onto the heating block 613 so as to press the circuit blocks 603 on the heating blocks 613 with the projection 617. By doing so, even in the case that the tape substrate 601 is deformed into, for example, a wavy shape, it is possible to uniformly transfer heat to the tape substrate 601 and to stably perform the solder melting processing. In addition, by setting the interval between the projections 617 to correspond to the length of the circuit blocks 603, it is possible to press the circuit blocks 603 at the boundary of the respective circuit blocks 603 and to prevent any mechanical damage from being inflicted on the electronic components arranged on the circuit blocks 603.

Furthermore, when a predetermined time elapses after the stop of the transport of the tape substrate 601, the tape substrate 601 is transported by a predetermined length and specified circuit blocks 603 on the tape substrate 601 are sequentially stopped on the respective heating blocks 611 to 614. This makes it possible to continuously perform the preheating, the main heating, and the cooling on the specified circuit blocks 603 on the tape substrate 601. As a result, it is possible to incrementally raise the temperature of the specified circuit block 603 on the tape substrate 601 step-by-step, carry out the reflow process while suppressing thermal damage on the circuit block 603, and rapidly lower the temperature of the solder melted circuit blocks 603, so that thermal oxidation of the solder can be suppressed and the product quality can be improved.

In addition, the specified circuit block 603 in the tape substrate 601 is sequentially contacted with each of the heating blocks 611 to 614, so that while surely maintaining the difference in temperature at the boundaries between the heating blocks, it is possible to rapidly raise and lower the temperature of the circuit blocks 603, rapidly shift the circuit blocks 603 to a set temperature, and thus efficiently perform the reflow process.

For this reason, even though the reflow process is performed continuously on the same tape substrate 601 after the soldering process and the mounting process, no delay occurs in the soldering process and the mounting process due to the rate-limitation in the reflow process so that the production efficiency can be prevented from being further deteriorated.

In other words, in case that the solder applying process and the mounting process on the circuit block 603 in the solder applying zone 22 and the mounting zone 23 have been completed, respectively, but the reflow process on the circuit block 603 in the reflow zone 24 has not been completed, the tape substrate 601 can not be transported until the reflow process on the circuit block 603 in the reflow zone 24 is completed. For this reason, in the case that it takes longer to perform the reflow process in comparison to the solder applying process and the mounting process, it is necessary to idle the solder applying process and the mounting process for the circuit block 603 in the solder applying zone 22 and the mounting zone 23 until the reflow process on the circuit block 603 in the reflow zone 24 is completed, so that the operating efficiency of the solder applying zone 22 and the mounting zone 23 are lowered and then the production efficiency is lowered.

Here, by making the tape substrate 601 contact the heating blocks 611 to 614, it becomes possible to rapidly shift the tape substrate 601 to a setting temperature and rapidly perform the reflow process. Accordingly, even though the solder applying process, the mounting process and the reflow process are performed as a unit, it is possible to prevent the operating efficiency in the solder applying zone 22 and the mounting zone 23 in FIG. 1 from being lowered due to any rate-limiting in the reflow zone, and improve production efficiency.

Furthermore, by consecutively arranging in parallel a plurality of heating blocks 611 to 614 in the transport direction of the tape substrate 601, it becomes possible to incrementally raise the temperature of the circuit block 603 step-by-step without increasing the time for the reflow process, and thus it becomes also possible to carry out the reflow process while suppressing thermal damage.

For this reason, even when the solder applying process, the mounting process and the reflow process are performed simultaneously as a unit, it is possible to optimize the temperature profile in the reflow process while preventing the rate of the respective processes from being limited by the reflow process, and it is also possible to improve production efficiency without deteriorating product quality.

Here, the length of the tape substrate 601 transported by one transport tact can be adapted to correspond, for example, to the length of the area to which solder is applied by the transport tact in the solder applying zone 22 in FIG. 3. Furthermore, the length of the solder applied area formed in one transport tact can be an integral multiple length of one circuit block 603.

In addition, in the solder applying zone 22 in FIG. 1, a plurality of the circuit blocks 603 are solder-applied simultaneously as a unit in one transport tact so that it is possible to perform the reflow process simultaneously on a plurality of the circuit blocks 603 step-by-step, and it is possible to improve production efficiency without deteriorating product quality.

And also, it is not necessary to match the length of the solder applied area applied in one transport tact to the length of three heating blocks 611 to 614, and it may be possible for the lengths of the heating blocks 611 to 614 to be longer that the length of the solder applied area applied in one transport tact. Accordingly, even though the lengths of the circuit blocks 603 of the tape substrate 601 is changed, it is possible to transport the tape substrate 601 while heating the specified circuit block 603 on all the heating blocks 611 to 614 for more than a predetermined time without exchanging the heating blocks 611 to 614, and it is possible to improve the production efficiency while suppressing deterioration of product quality.

The maximum of the length of the solder applied area applied during one transport tact can be set to, for example, 320 mm, and the length of the respective heating blocks 611 to 614 can be set to, for example, 361 mm. And, one pitch of the feed hole 602 in FIG. 12 can be, for example, 4.75 mm, and the length of one circuit block 603 can be changed, for example, within a range of length of six to fifteen pitches of the feed hole 602. In this case, the length of the solder applying area applied in one transport tact can be set not to exceed the maximum of 320 mm and such that the number of the circuit blocks 603 can be maximized. For example, if the length of one circuit block 603 is the length of eight pitches of the feed hole 602, the length of one circuit block 603 is 4.75×8=38 mm, and the length of the solder applying area applied in one transport tact can be the length of eight circuit blocks 603=304 mm<320 mm. For this reason, the length of the tape substrate 601 transported in one transport tact can be set to 304 mm.

If each length of the heating blocks 611 to 614 is set to be longer than the length of the solder applying area applied in one the transport tact and the length of the tape substrate 601 transported as a unit in one transport tact is set to the length of the solder applying area, at least some portion of the same circuit block 603 is stopped multiple times on the same one of the heating blocks 611 to 614 so that the portion may be subjected to the heating longer. For this reason, if the temperature of heating blocks 611 to 614 and tact time are set to have some margin in the heating time, it is possible to maintain the quality of the reflow process.

Also, by arranging the heating blocks 611 to 614 with a predetermined interval therebetween, so that it is possible to definitely maintain the temperature of a boundary between the heating blocks 611 to 614, uniformly keep the setting temperature over all the areas of the circuit blocks 603, and thus it is possible to maintain the product quality of the reflow process uniformly.

In addition, in arranging the heating blocks 611 to 614 with a predetermined interval therebetween, an insulating resin such as Teflon (a registered trademark) may be provided in the gap between the heating blocks 611 to 614 so that the thermal conductivity between the heating blocks 611 to 614 can be lowered even further.

Next, as shown in FIG. 13(c), in the case that any trouble occurs in the solder applying zone 22 or the mounting zone 23, or elsewhere, (FIG. 1 and step S3 in FIG. 14), the heating blocks 611 to 614 may be lowered (step S5 in FIG. 14).

Next, the shutter plates 615a, 615b are moved horizontally to be over the heating blocks 611 to 614, and are inserted above and below the tape substrate 601, respectively (step S6 in FIG. 14).

By doing so, for example, even in the case that a if trouble occurs in the solder applying zone 22 or the mounting zone 23, or elsewhere, (FIG. 1) that causes the transporting of the tape substrate 601 to stop for a long time, it is possible to prevent the heating of the tape substrate 601 from being prolonged more than necessary, and it is possible to reduce thermal oxidation and contact failure of solder.

In addition, by inserting the shutter plates 615a, 615b above and below the tape substrate 601, respectively, it is possible to make the temperature distribution uniform on the upper and lower sides of the tape substrate 601, and it is possible to prevent the tape substrate 601 from being deformed into, for example, a wavy shape.

Next, as shown in FIGS. 13(d) to 13(f), once the trouble which occurred in the solder applying zone 22 or the mounting zone 23, etc., in FIG. 1 is solved (step S7 in FIG. 14), the shutter plates 615a, 615b are retracted (step S8 in FIG. 14). Then, while the position of the heating blocks 611 to 614 are adapted to be raised step-by-step (step S9 in FIG. 14), the heating blocks 611 to 614 are moved to contact the tape substrate 601.

By doing so, even in the case that the tape substrate 601 in the heating blocks 611 to 614 has been cooled because of a prolonged separation from the heating blocks 611 to 614, it is possible to incrementally raise the temperature of the circuit blocks 603 in each of the heating blocks 611 to 614 step-by-step, while the transport of the tape substrate 601 is stopped.

Accordingly, it is not necessary to rewind the tape substrate 601 and to restart the transporting of the tape substrate 601 again in order to raise the temperature of the circuit block 603 on each of the heating blocks 611 to 614 step-by-step. Therefore, it is possible to resume the reflow process without making the transport system complicated.

In the above mentioned embodiments, although a method for separating all the heating blocks 611 to 614 from the tape substrate 601 is described when removing the tape substrate 601 from the heating, it may be possible that, for example, only the heating block 613 is separated from the tape substrate 601, while the heating blocks 611, 612, and 614 are kept in contact the tape substrate 601. By doing so, even in the case that a trouble occurs, for example, in the solder applying zone 22 or the mounting zone 23, etc., (FIG. 1), and the transporting of the tape substrate 601 is stopped for a long time, it is possible to interrupt the main heating process while preheating the circuit blocks 603 of the tape substrate 601 is continuously, and thus it is possible to reduce product failures.

Although in the embodiment in FIG. 12, a method including only the four heating blocks 611 to 614 is illustrated, it may be possible that more than five heating blocks 611 to 614 may be arranged in parallel to perform the preheating on the circuit blocks 603 more moderately or to perform the cooling on the circuit block 603 step-by-step.

In addition, although the method regarding each of the heating blocks 611 to 614 constructed in the shape of a plate is described, it may be possible to provide a concave portion on some of the contact surfaces of the heating blocks 611 to 614, for example, at a portion in contact with an area where semiconductor chips are mounted. This makes it possible to prevent the heating blocks 611 to 614 form directly contacting the area where the semiconductor chips are mounted. As a result, even in the case that a semiconductor chip which is vulnerable to heat is mounted on the tape substrate 601, it is possible to suppress thermal damage on the semiconductor chip.

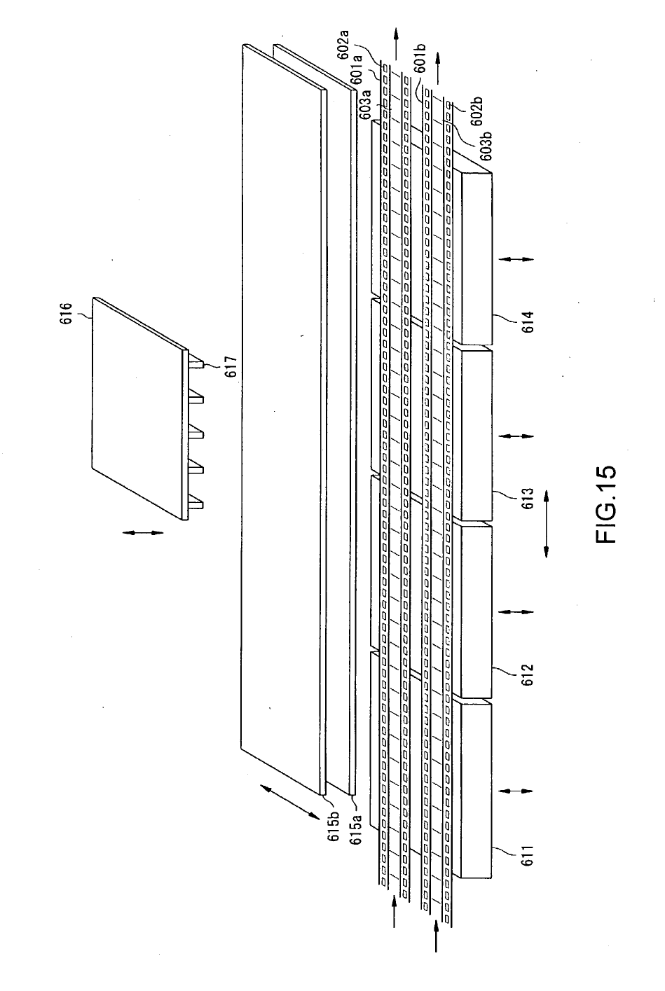

FIG. 15 is a perspective view illustrating a schematic construction of an apparatus for manufacturing an electronic device in accordance with an eighth embodiment of the present invention.

In FIG. 15, circuit blocks 603a and 603b are longitudinally provided on tape substrate 601a and 601b, and an electronic component mounting area is provided in the respective circuit blocks 603a and 603b. Feed holes 602a, 602b are provided on both sides of each of the tape substrates 601a, 601b at a predetermined pitch in order to transport the tape substrates 601a and 601b.

Furthermore, two tape substrates 601a, 610b are arranged in parallel on the heating blocks 611 to 614. These two tape substrates 601a and 601b are transported in contact with the heating blocks 611 to 614. As a result, it is possible to carry out the reflow process on the two tape substrates 601 on the heating blocks 611 to 614 simultaneously and to improve production efficiency.

Although it has been described that the two tape substrates 601a and 601b are transported in parallel onto the heating blocks 611 to 614, three or more tape substrates may be transported in parallel onto the heating blocks 611 to 614.

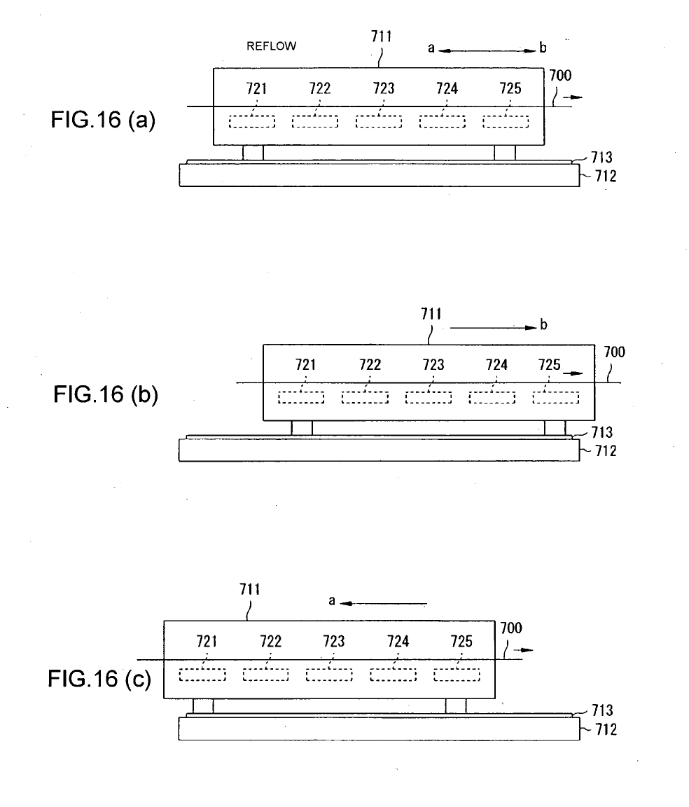

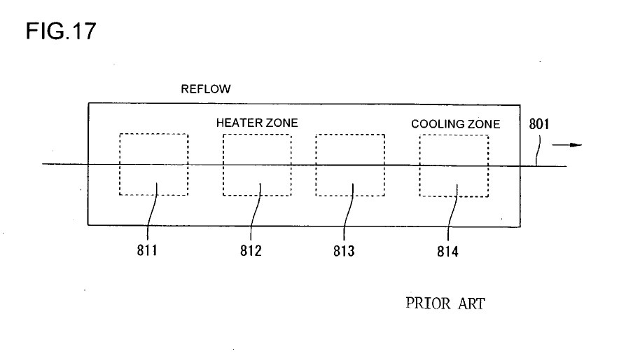

FIG. 16 is a side view illustrating an apparatus for manufacturing an electronic device in accordance with a ninth embodiment of the present invention.

Referring to FIG. 16(a), a reflow furnace 711 is supported by a supporting stand 712 having a rail 713. Here, the reflow furnace 711 is provided with heater zones 721 to 724 for incrementally raising the temperature of the circuit substrates step-by-step by carrying out the heating on the circuit substrates as bodies to be heated and sequentially arranged on the tape substrate 700, and a cooling zone 725 for lowering the temperature of the circuit substrate step-by-step by carrying out the cooling on the circuit substrate, for example, in the reflow process to be carried out after the soldering process and the mounting process. Furthermore, the reflow furnace 711 may process a plurality of circuit substrates arranged on the tape substrate 700 simultaneously or may independently process the circuit substrates arranged on the tape substrate 700 one by one.

Furthermore, as shown in FIGS. 16(b) and 16(c), the reflow furnace 711 is movable in the direction of arrow a-b along the rail 713 of the supporting stand 712. The direction of arrow a-b corresponds to the transport direction of the tape substrates 700. Like this, the reflow furnace 711 can freely move in the direction of arrow a-b, so the heater zones 721 to 724 and the cooling zone 725 can be set at a position corresponding to the product pitches of the circuit substrate.

The entire disclosures of Japanese Patent Application Nos. 2002-081220 filed Mar. 22, 2002, 2002-081221 filed Mar. 22, 2002, 2002-081222 filed Mar. 22, 2002, 2002-084347 filed Mar. 25, 2002, and 2003-024650 filed Jan. 31, 2003 are incorporated by reference.

What is claimed is:

1. An apparatus for manufacturing an electronic device comprising:
a moveable heat generating means for raising a temperature of an area to be heated of a continuous body by controlling a distance between the heat generating means and said area of said continuous body to be heated, said continuous body including a plurality of circuit blocks and an electronic component mounting area is provided on every circuit block.

2. The apparatus for manufacturing an electronic device according to claim 1, wherein said heat generating means further comprises a heat generating means for raising the temperature of said area to be heated by at least one of approaching and contacting at least a part of said area of the continuous body to be heated.

3. The apparatus for manufacturing an electronic device according to claim 2, wherein said heat generating means further comprises a heat generating means for contacting at least one of a top and bottom side of said continuous body.

4. The apparatus for manufacturing an electronic device according to claim 1, wherein said heat generating means further comprises a heat generating means for incrementally controlling the temperature of said area to be heated by controlling at least one of the speed and the position of the continuous body relative to the heat generating means.

5. The apparatus for manufacturing an electronic device according to claim 1, wherein said heat generating means is moveable in at least one of a vertical and a horizontal direction relative to the continuous body.

6. The apparatus for manufacturing an electronic device according to claim 1, wherein said heat generating means further comprises a heat generating means for contacting the same area to be heated a plurality of times.

7. The apparatus for manufacturing an electronic device according to claim 1, wherein said heat generating means has a contact area that is greater than a solder applying area applied to said circuit blocks, and said heat generating means further comprises a heat generating means for raising the temperatures of more than one of said plurality of circuit blocks simultaneously.

8. The apparatus for manufacturing an electronic device according to claim 1, wherein said heat generating means includes a plurality of contact areas having different predetermined temperatures that are sequentially contactable with said area to be heated.

9. The apparatus for manufacturing an electronic device according to claim 8, wherein said plurality of contact areas having different predetermined temperatures are arranged in parallel in a transport direction of said continuous body.

10. The apparatus for manufacturing an electronic device according to claim 8, wherein a gap is provided between said contact areas.

11. The apparatus for manufacturing an electronic device according to claim 8, wherein said plurality of contact areas are individually moveable.

12. The apparatus for manufacturing an electronic device according to claim 1, wherein said heat generating means includes a contact surface for contacting said area to be heated, said contact surface being flat.

13. The apparatus for manufacturing an electronic device according to claim 12, wherein said contact surface includes a concave portion corresponding to a position of a semiconductor chip on said area to be heated.

14. The apparatus for manufacturing an electronic device according to claim 1, further comprising moveable shutter means that are removeably positionable between said area of said continuous body to be heated and said heat generating means.

15. The apparatus for manufacturing an electronic device according to claim 1, further comprising:
timer means for tracking a heating time of said area to be heated by said heat generating means; and
retracting means for retracting said heat generating means from said area to be heated when said heating time exceeds a predetermined time.

16. The apparatus for manufacturing an electronic device according to claim 1, further comprising:
a supporting stand supporting said heat generating means; and
slide means for sliding said supporting stand along the transport direction of said continuous body.

17. The apparatus for manufacturing an electronic device according to claim 1, further comprising:
auxiliary heating means for heating said area to be heated of said continuous body from a direction that is different from a heating direction of said heat generating means.

18. The apparatus for manufacturing an electronic device according to claim 1, further comprising:
temperature lowering means for lowering the temperature of said area to be heated, which was raised by said heat generating means.

19. The apparatus for manufacturing an electronic device according to claim 18, wherein said temperature lowering means includes a flat plate member having a plurality of coolant blowout holes along a side of the temperature lowing means facing said area to be heated.

20. The apparatus for manufacturing an electronic device according to claim 18, wherein said temperature lowering means includes:
a covering and sandwiching opening having a U-shaped cross-section selectively covering and sandwiching said area to be heated; and
a plurality of coolant blowout holes provided inside said covering and sandwiching hole.

21. The apparatus for manufacturing an electronic device according to claim 18, wherein said temperature lowering means includes an area of lower temperature than said heat generating means which is selectively contactable with at least a part of said area to be heated of said continuous body.

22. The apparatus for manufacturing an electronic device according to claim 21, wherein said lower temperature area has a larger contact area than a solder applying area applied by a solder applying means which lowers the temperature of the plurality of circuit blocks simultaneously.

23. The apparatus for manufacturing an electronic device according to claim 21, wherein said lower temperature area is arranged in at least one position relative to a direction of movement of the continuous body selected from the group including:
in front of said heat generating means;
in back of said heat generating means; and
between a pair of said heat generating means.

24. A method of manufacturing an electronic device, wherein, by controlling a distance between an area of a continuous body to be heated and heat generating means, a temperature of said area to be heated is raised, said continuous body including a plurality of circuit blocks and an electronic component mounting area is provided on every circuit block,.

25. The method of manufacturing an electronic device according to claim 24, wherein by making said heat generating means do at least one of approach and contact at least a part of said area of said continuous body to be heated, the temperature of said area to be heated is raised.

26. The method of manufacturing an electronic device according to claim 25, wherein multiple ones of said plurality of circuit blocks are contacted with said heat generating means simultaneously.

27. The method of manufacturing an electronic device according to claim 25, wherein the same circuit block is contacted with said heat generating means a plurality of times.

28. The method of manufacturing an electronic device according to claim 24, further comprising:
transporting a first area of said continuous body to be heated onto said heat generating means;
raising a temperature of said first area to be heated by contacting said first area to be heated with said heat generating means;
transporting a second area of said continuous body to be heated onto said heat generating means; and
raising a temperature of said second area to be heated by contacting said second area to be heated with said heat generating means.

29. The method of manufacturing an electronic device according to claim 24, further comprising:
transporting said area of said continuous body to be heated onto said heat generating means; and
incrementally raising the temperature of said area to be heated by repeatedly making said heat generating means approach said area to be heated.

30. The method of manufacturing an electronic device according to claim 24, further comprising a step of retracting said heat generating means from said area to be heated.

31. The method of manufacturing an electronic device according to claim 30, further comprising inserting a heat-shielding plate between said retracted heat generating means and said area to be heated.

32. The method of manufacturing an electronic device according to claim 30, further comprising re-contacting said heat generating means, which was retracted from said area to be heated, with said area to be heated.

33. The method of manufacturing an electronic device according to claim 32, further comprising blowing hot air against said area to be heated before re-contacting said heat generating means with said area to be heated.

34. The method of manufacturing an electronic device according to claim 24, further comprising:
transporting a first area of said continuous body to be heated onto a first heat generating means and transporting a second area of said continuous body to be heated onto a second heat generating means which has a higher temperature than a temperature of said first heat generating means; and
raising a temperature of said first area to be heated by contacting said first area to be heated with said first heat generating means, and raising a temperature of said second area to be heated to a higher temperature than said first area to be heated by contacting said second area to be heated with said second heat generating means.

35. The method of manufacturing an electronic device according to claim 34, wherein said first heat generating means and said second heat generating means are arranged in a transport direction of said continuous body such that said first heat generating means is upstream of said second heat generating means relative to said transport direction.

36. The method of manufacturing an electronic device according to claim 34, further comprising retracting said second heat generating means from said second area to be heated while contacting said first heat generating means with said first area to be heated.

37. The method of manufacturing an electronic device according to claim 36, further comprising re-contacting said second heat generating means, which was retracted from said second area to be heated, with said second area to be heated.

38. The method of manufacturing an electronic device according to claim 37, further comprising a step of blowing hot air against said second area to be heated, before re-contacting said second heat generating means with said second area to be heated.

39. The method of manufacturing an electronic device according to claim 38, further comprising sliding a stand supporting said heat generating means along the transport direction of said continuous body to position said heat generating means to correspond to product pitches along said continuous body.

40. The method of manufacturing an electronic device according to claim 24, further comprising lowering the temperature of said area to be heated, which was raised by said heat generating means.

41. The method of manufacturing an electronic device according to claim 40, wherein by contacting an area having a lower temperature than said heat generating means with at least a part of said area to be heated, the temperature of said area to be heated is lowered.

42. The method of manufacturing an electronic device according to claim 41, wherein said lower temperature area is arranged in a position relative to a transport direction of said continuous body selected from the group including:
in front of said heat generating means;
parting back of said heat generating means; and
between a pair of said heat generating means.

43. The method of manufacturing an electronic device according to claim 40, wherein by blowing a gas against at least one surface of said area to be heated, which was previously heated by said heat generating means, the temperature of said area to be heated is lowered.

44. A program for manufacturing an electronic device which makes a computer execute a step of raising a temperature of an area to be heated by controlling a distance between an area of a continuous body to be heated and heat generating means, the continuous body including a plurality of circuit blocks and an electronic component mounting area is provided on every circuit block,.
